(19) United States
(12) Patent Application Publication
(10) Pub. No.: US 2018/0257457 A1
(43) Pub. Date: Sep. 13, 2018

(54) MULTIPLE MODES OF APPLYING HEAT TO A VEHICLE DEVICE WITH A HEATING ELEMENT

(71) Applicant: FORD GLOBAL TECHNOLOGIES, LLC, Dearborn, MI (US)

(72) Inventors: Matthew William Michael Olson, Saline, MI (US); Sean Bayle West, Monroe, MI (US); James Robert Chascsa, II, Farmington Hills, MI (US); Karl Derek Kiefer, Clinton Township, MI (US); Kenneth Michael Landis, South Lyon, MI (US)

(21) Appl. No.: 15/452,277

(22) Filed: Mar. 7, 2017

(51) Int. Cl. B60H 1/22; H05B 3/00; B62D 1/06; B60N 2/56; B60N 2/48

(52) U.S. Cl. CPC B60H 1/2218; H05B 3/0019; B62D 1/065; B60N 2/5685; B60H 2001/225; H05B 2203/029; H05B 2203/031; B60H 2001/2228; B60N 2/4876

(57) ABSTRACT

A vehicle includes a heating system to selectively heat a vehicle device structured for contact by a vehicle occupant or for the occupant to view surroundings outside the vehicle from inside it. In one form, the vehicle device is a steering wheel, and the heating system encompasses a vehicle power supply electrically coupled to a rechargeable energy source to energize a heating element that together increase device temperature more rapidly than with just one of them alone. The heating system detects depletion of the rechargeable energy source and recharges it with the vehicle power supply, while increasing the temperature more slowly because the heating element is only being energized by the vehicle power supply. If the temperature is greater than or equal to a target level, energization of the heating element includes some form of time-varying modulation to approximately maintain the temperature target level.

### TECHNICAL FIELD

The present application relates to vehicle equipment heating techniques, and more particularly, but not exclusively, relates to techniques to more rapidly heat-up a vehicle device with a heating element energized by multiple electric power sources. Additionally or alternatively, the present invention relates to multiple modes of applying heat to a vehicle device.

### BACKGROUND

There is a persistent desire to provide a more comfortable operating environment for vehicle occupants, including both vehicle passengers and operators. Among other things, this desire has resulted in better control over air temperature in the occupant compartment of the vehicle. Unfortunately, environmental control of a vehicle occupant compartment can prove difficult when there is an appreciable thermal time constant, when operating under extremely cold conditions, or when power available to perform warming is limited. Reliable heating of various vehicle equipment features during cold or otherwise inclement weather can be particularly challenging. Indeed, especially during cold weather, there is a pressing desire to more rapidly heat-up certain vehicle devices—particularly those structured for direct contact with an occupant's skin or apparel. Thus, there is an ongoing demand for further contributions in this area of technology.

By way of transition from this Background to subsequent sections of the present application, one or more abbreviations, acronyms, and/or definitions are set forth below and supplemented by example or further explanation where deemed appropriate. Among other things, these definitions are provided to: (a) resolve meaning sometimes subject to ambiguity and/or dispute in the applicable technical art(s) field(s) and/or (b) exercise the lexicographic discretion of any named inventor(s), as applicable:

1. “Direct Current” (DC) means an electric current that is unidirectional, a flow of like electrical charge that is unidirectional, an electric current that is not of the AC type, or an electric current or electric charge flow that does not reverse direction. Magnitude of an electric current of the DC type can vary from zero to a maximum that depends on the electrical load drawing such electric current, the capability of the equipment supplying the electric current, any variation in magnitude of the voltage supplied by such equipment, or the like. To the extent an electric current reverses direction on a temporary, aperiodic basis due to failure, operator error, reactive loading, poor electrical grounding, noise, or the like; any duration of the electric current prior or subsequent to such reversal is the DC type. Certain components of DC electric power supplies and associated equipment often utilize protective diodes or other semiconductors that prevent electric current reversal of the supply overall or for selected parts thereof likely to be irreversibly damaged (such as certain vehicle supply batteries, various accessories, and the like). Even so, any relatively long, aperiodic or periodic duration of unidirectional electric current is still considered DC for the purposes of the present application even if there is a relatively short or minor polarity reversal.

2. “DC Voltage” (VDC) means a voltage or electric potential that provides electric current or electric charge flow of the DC type, is not an AC voltage, or a voltage output that does not reverse polarity. Magnitude of a DC voltage can vary between zero and a maximum that depends on the electrical load to which such DC voltage is supplied, the capability of the equipment supplying the DC voltage, the magnitude of electric current supplied by such equipment including any variation in such magnitude, or the like. Commonly electric power supplies output a DC voltage with a magnitude that remains approximately constant over time subject to a specified tolerance or is supplied within a specified magnitude range. For a nominal 12 VDC vehicle power supply typical of many automobiles, the DC voltage magnitude can vary considerably, sometimes as low as 11 VDC when the supply is solely supported by a highly discharged lead-acid vehicle battery to as much as 15 VDC from the a rectified output of a polyphaser alternator of the supply. VDC magnitude of a typical vehicle power supply can further vary depending on a number of factors such as temperature, state of charge and the type of a vehicle supply battery (or batteries) included (if any), characteristics of any associated alternator or motor/generator from which a rectified VDC is derived, degree and nature of any voltage regulation, electrical loading of the supply, whether the vehicle is fully electric and/or has hybrid characteristics, and the like. Many DC voltage supplies provided by vehicles are produced by full-wave rectification of a three-phase alternator type of electric power generator driven by an internal combustion engine. These systems usually include a primary battery across the supply voltage that is charged while the alternator is receiving mechanical rotary power from the engine. When the engine is not in operation, this battery provides electric power for engine start-up, powering various vehicle accessories, and the like. Depending on the presence, type, and degree of voltage regulation and/or filtering provided in a given vehicle DC voltage power supply, a slight voltage ripple may be present on top of a generally constant DC voltage offset from the zero magnitude level—particularly for that part of the vehicle supply that charges the supply battery.

3. “Alternating Current” (AC) means a time-varying electrical current or electrical charge flow that: (a) periodically reverses direction (such as a repeating sinusoidal waveform, square waveform, triangle waveform, or the like), or (b) reverses direction on an aperiodic basis but averages about the same amount of time in both the unreversed and reversed directions.

4. “AC Voltage” (VAC) means a time-varying voltage that: (a) periodically reverses polarity (such as a repeating sinusoidal waveform, square waveform, triangle waveform, or the like), or (b) reverses polarity on an aperiodic basis but averages about the same amount of time with both the unreversed and reversed polarities.

5. “Pulse Width Modulation (PWM) means a periodic, time-varying signal (electric current, voltage, or both) with an established frequency and corresponding period with one pulse per period; where the pulse width relative to the given period varies over the range from zero percent (0%), that is no pulse for the given period, through one hundred percent (100%), that is a pulse as wide as the given period, and any of a number interim pulse widths relative to the period in between 0% and 100%. These interim pulse widths may be limited to a discrete finite set (say every 5% interval: 0%, 5%, 10%, 15%, . . . 100%) or continuously adjustable over such range. The resulting PWM pulse train is typically of a DC type with the pulses varying between a magnitude of zero and some set VDC, although its variants include AC types or types with different DC offsets.

6. “Single-Pole, Double-Throw” (SPDT) refers to a mechanical switch, an electromechanical relay, a semiconductor switch, or other type of switch with one common contact (the “single-pole”) that alternates electrical connection between two different contacts (the “double-throw”) whenever its setting changes. So if the common contact is electrically connected to a first one of the different contacts, then changing its setting breaks the electrical connection between the common contact and the first one of the different contacts, and instead the common contact makes an electrical connection with the second one of the different contacts. Changing the setting again reestablishes electrical contact with the first one of the different contacts and the common contact, and so on. The setting may be changed by mechanical movement, electrical signaling, optically, or the like.

7. “Double-Pole Double-Throw” (DPDT) refers to a mechanical switch, an electromechanical relay, a semiconductor switch, or other type of switch with two common contacts (the “double-pole”) that both alternate electrical connection between its own unique pair of two different contacts (the “double-throw”) (for a total of four contacts besides the two common contacts) whenever its setting changes. So if the first common contact is electrically connected to a first one of the first pair of contacts and the second common contacts is electrically connected to a first one of the second pair of contacts, then changing the setting breaks the electrical connection between both the common contacts and the first one of each of the first and second pairs of contacts, and instead the first common contact makes an electrical connection with the second one of the first pair of contacts and the second common contact makes an electrical connection with the second one of the second pair of contacts. Changing the setting again reestablishes the first electrical configuration, and so on. The setting may be changed by mechanical movement, electrical signaling, optically, or the like. It should be appreciated that a DPDT switch acts like two SPDT switches that are ganged together to always change setting simultaneously.

The above listing of one or more abbreviations, acronyms, and/or definitions apply to any reference to the corresponding subject terminology herein unless explicitly set forth to the contrary. Any acronym, abbreviation, or terminology defined in parentheses, quotation marks, or the like elsewhere in the present application likewise shall have the meaning imparted thereby throughout the present application unless expressly stated to the contrary or unless identical to an entry of the immediately preceding numerical listing of abbreviations, acronyms, and/or definitions, in which case such listing prevails. Any acronym, abbreviation, or definition provided herein applies irrespective of whether the abbreviated, defined and/or otherwise represented terminology is in lower case, upper case, or capitalized form, unless expressly stated to the contrary.

### SUMMARY

Certain implementations of the present application include unique techniques to reduce the time it takes a vehicle heating element to reach a desired temperature. Other forms include unique adaptations, additions, alternatives, applications, arrangements, articles, aspects, circuitry, configurations, developments, devices, discoveries, features, instrumentalities, kits, machines, manufactures, mechanisms, methods, modifications, operations, options, procedures, processes, refinements, systems, upgrades, uses, vehicles, variants of any of the foregoing, or the like to more quickly warm a vehicle device with multiple electrical energy sources via associated circuitry. Still a further aspect is directed to a vehicle with a heating system including circuitry with a heating element selectively energized in each of several operational modes in accordance with circuitry-executed operating logic in response to one or more inputs to provide heat to a vehicle device.

In a further form of the present application, a heating element rapidly heats-up a vehicle device from an unpleasantly cold temperature to a warmer temperature when supplied electric energy from multiple sources in concursion. The device is structured to make contact with an occupant inside the vehicle who finds the warmer temperature more agreeable than the cold temperature. In one nonlimiting example, the cold temperature is less than or equal to approximately 40° Fahrenheit (F) and the warmer temperature is greater than or equal to approximately 65° F. In a further refinement of this example, the cold temperature is less than or equal to approximately 32° F. (equivalent to 0° Celsius (C)), and the warmer temperature is greater than or equal to 72° F. In still other forms of the present application, no particular cold or warm temperature is involved.

While a vehicle device contacted by an occupant inside the vehicle is a good candidate for heating-up to a comfortable temperature, other good candidates for heating include vehicle-mounted: windows, mirrors, cameras, or the like that are used to view surroundings external to the vehicle by an occupant inside the vehicle. Under certain meteorological conditions (like temperatures below freezing—32° F. or less), such devices can become at least partially occluded by frost, snow, ice, or the like—potentially impairing operator visibility so much that vehicle operation can become unsafe. Nonetheless, by bringing this kind of device to a warmer temperature (say significantly greater than 32° F.)—defrosting and thawing of visually obstructive frost, snow, and ice by a sufficient amount may restore visibility to the level sought to safely operate the vehicle. Under yet other meteorological conditions, rain, mist, or fogging may at least partly block operator visibility through a window or windshield, or with a vehicle-mounted outdoor mirror or camera, which can also be addressed by heating to a sufficiently warm enough temperature.

Other implementations of the present application include increasing temperature of a vehicle steering device with a heating element energized by a first DC voltage from a vehicle power supply electrically coupled to a rechargeable energy source. In response to an operational state change caused by the increasing of the temperature, electrical connectivity of the vehicle power supply and the rechargeable energy source undergoes reconfiguration to output a second DC voltage. This second DC voltage energizes the heating element to provide heat to the vehicle steering device and recharges the rechargeable energy source. In certain refinements, the vehicle steering device is a steering wheel of the type common to on-road automobiles.

Another arrangement of the present application includes a vehicle and a heating system carried thereby. This system comprises a heating element that when energized, heats-up an outer surface of one or more of: a vehicle control, a seat base, a seat back, a vehicle-mounted cushion, a headrest, an armrest, a center console, a floorboard, a floor mat, a window, a windshield, a vehicle-mounted mirror, and a vehicle-mounted camera. This arrangement further includes: a vehicle power supply to output a DC supply voltage, a rechargeable energy source to output a DC source voltage, an input device to initiate heat-up of the outer surface by the heating element, and control circuitry. This control circuitry responds to the input device to provide the vehicle power supply, the rechargeable energy source, and the heating element in a first circuit to output a first DC voltage to electrically energize the heating element to increase the temperature of the outer surface at a first rate. In response to an operational state change caused by the increase of the temperature, the control circuitry couples the vehicle power supply, the rechargeable energy source, and the heating element in a second circuit to output a second DC voltage to provide heat to the outer surface at a second rate less than the first rate with the second circuit being further operable to charge the rechargeable energy source.

Yet other forms of the present application are directed to a vehicle with a heating system and a process for using the same. In one implementation, this heating system/process includes a vehicle power supply electrically coupled to a rechargeable energy source for energizing a heating element to increase temperature of a vehicle device at a first rate. This vehicle device is structured for contact by skin or apparel of a vehicle occupant or for viewing surroundings outside the vehicle from inside it. The heating system/process also provides for detecting depletion of the rechargeable energy source, and increasing the temperature of the vehicle device at a second rate less than the first rate with the heating element energized from the vehicle power supply in response to the depletion. Also included is determining if the vehicle device temperature is greater than or equal to a target level, and controlling energization of the heating element to approximately maintain the target level of the device temperature.

Still a further arrangement is directed to: heating a steering wheel with a heating element energized with a first DC voltage from a vehicle power supply electrically coupled to a rechargeable energy source. Responsive to an operational state change caused by the heating, the heating system/process continues by providing heat to the steering wheel with the heating element energized with a second DC voltage from the vehicle power supply that is less than the first DC voltage, and recharging the rechargeable energy source with the second DC voltage.

The above introduction to the present application is not to be considered exhaustive or exclusive in nature—merely serving as a forward to further advances, advantages, approaches, attributes, benefits, characteristics, contributions, efficiencies, features, gains, goals, improvements, incentives, influences, objectives, operations, principles, progressions, purposes, savings, uses, variants of any of the foregoing, or the like. Other adaptations, additions, alternatives, apparatus, applications, arrangements, articles, aspects, circuitry, configurations, developments, devices, discoveries, forms, implementations, instrumentalities, kits, machines, manufactures, mechanisms, methods, modifications, operations, options, procedures, processes, refinements, systems, upgrades, uses, vehicles, variants of any of the foregoing, or the like shall become apparent from the description provided herewith, any attendant drawing figures, any patent claim appended hereto, or any other information provided herewith.

### BRIEF DESCRIPTION OF THE DRAWING FIGURES

Throughout the present application, occurrence of a reference numeral in one drawing figure like that in a previously introduced drawing figure refers to the like feature already described for the previous occurrence thereof. The accompanying drawing figures incorporated herein and forming a part of the specification, illustrate several aspects of the present application, and together with the description explain certain principles thereof.

FIG. 1 depicts a partially diagrammatic view of a vehicle carrying a heating system with certain hidden features depicted in phantom (dashed lines), while others (such as a hidden part of the steering wheel) are not shown in phantom to preserve clarity.

FIG. 2 is a partially diagrammatic view of the steering wheel of the heating system of FIG. 1 with partial cut-away portions showing further details thereof.

FIG. 3 depicts a schematic view of the heating circuitry of FIG. 1 introducing monitoring circuitry, control circuitry, a vehicle power supply, steady-state temperature control circuitry, heat-up circuitry with a rechargeable energy source, charger circuitry, and switch circuitry (including a heating element connection switch); and further depicts the operator input device of FIG. 1 and the heating element of FIGS. 1 & 2.

FIG. 4 depicts a further schematic view of the heating circuitry of FIGS. 1 & 3 that further details selected aspects of the heating element, the control circuitry, the vehicle power supply, the rechargeable energy source, and the switch circuitry (including the heating element connection switch); and introduces certain detection circuitry.

FIG. 5 depicts still another schematic view of the heating circuitry of FIGS. 1, 3, & 4 showing additional details regarding the heating element, the heating element connection switch, the control circuitry, and the steady-state temperature control circuitry (including its amplifier circuitry).

FIGS. 6-8 depict a flow chart for a procedure to provide heat to a vehicle device of the type shown in FIG. 1 and described in accompanying text that uses the heating system detailed in FIGS. 1 & 2 and the heating circuitry detailed in FIGS. 3-5; however, in other implementations, it may be performed without the particulars of the heating system and/or heating circuitry in whole or in part. This procedure involves several different modes, processes, and operations relating to the application of heat to such vehicle device in general and in a more specific example, the steering wheel of the vehicle as shown in FIGS. 1 & 2.

### DETAILED DESCRIPTION

In the following description, various details are set forth to provide a thorough understanding of the principles and subject matter of the content described or illustrated herein, or set forth in any patent claim appended hereto. To promote this understanding, the description refers to certain representative aspects—using specific language to explicate the same accompanied by any drawing figures to the extent the description subject matter admits to illustration. In other instances, when the description subject matter is well-known, such subject matter may not be described in detail and/or may not be illustrated to avoid obscuring information that is to be conveyed in detail. Considering further any patent claim that follows, those skilled in the relevant art will recognize that the same can be practiced without one or more specific details included in the description. Further, the full scope of any patent claims can encompass, cover, read on, or otherwise extend or apply to any instance in which one or more various unexpressed aspects exist in addition to that subject matter made explicit therein. Such unexpressed aspects can be directed to anything that is additional to that explicitly recited with respect to any patent claim that follows. Accordingly, this description sets forth representative examples only and does not limit the scope of any patent claims provided herewith.

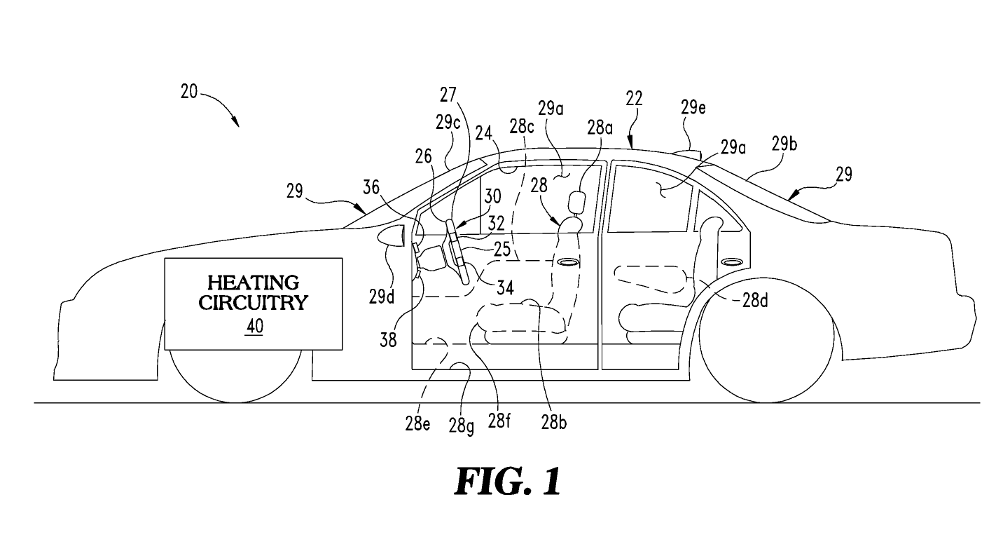

FIG. 1 illustrates heating system 20 carried with vehicle 22 in one representative form of the present application. Vehicle 22 includes occupant compartment 24. Occupant compartment 24 is suitable to seat up to 4 or 5 occupants, with one being the vehicle operator while any others are passengers. Vehicle 22 is illustrated in the form of an automobile, but it may take any form such as a sport utility vehicle (SUV), a cross over vehicle, a pick-up truck, a van, a motor coach, a tractor-trailer, a firetruck, an ambulance, a concrete mixer, a dump truck, a semi-autonomous motor vehicle, an autonomous motor vehicle, certain farm machinery (e.g. an arm tractor), a backhoe, some other type of on-road or off-road vehicle, a watercraft, or an aircraft—just to name a few examples. Within occupant compartment 24, heating system 20 includes a “heatable” vehicle device 25 in the form of vehicle control 26 that is structured to contact skin or apparel of a vehicle occupant. Vehicle control 26 is a type of vehicle steering device 27 for a vehicle operator or driver to direct travel of vehicle 22 (where a vehicle operator or driver is one particular type of vehicle occupant as distinct from one or more optional passenger occupants in occupant compartment 24 of vehicle 22). More specifically, vehicle steering device 27 is a type of vehicle steering wheel 30 that can be utilized by a vehicle operator to steer vehicle 22 when driving and can be heated in conjunction with heating circuitry 40 included in heating system 20. In other arrangements, it should be recognized that vehicle steering device 27 can be provided as one or more levers or paddles, a joystick, a control stick, or the like, and likewise selectively be heated. As an alternative or addition to steering wheel 30, other types of vehicle controls 26 can be heated that are structured for occupant contact by skin or apparel. Besides steering wheel 30, many other types of vehicle device 25 in occupant compartment 24 routinely come into occupant contact that are a good candidates for heating, including: seat back 28, vehicle-mounted cushion 28f, headrest 28a, seat base 28b, central console 28c, armrest 28d, floor mat 28e, and/or floorboard 28g. Other candidates for selective heating are windows 29, nominally transparent constituents that enclose occupant compartment 24, through which the view of surroundings outside of vehicle 22 can become at least partly blocked by frost, ice, snow, mist, fog, or the like with respect to an occupant sitting inside the vehicle. Windows 29 include rear-view window 29b, side windows 29a, and windshield 29c. At least partial blocking of vehicle-mounted side-view mirror 29d or rear-view camera 29e (each external to occupant compartment 24) can also potentially benefit from the selective application of heat.

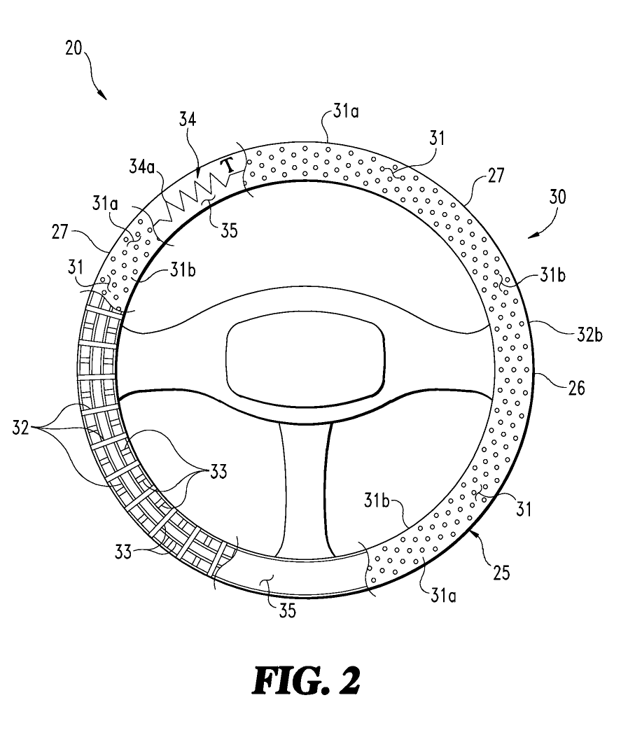

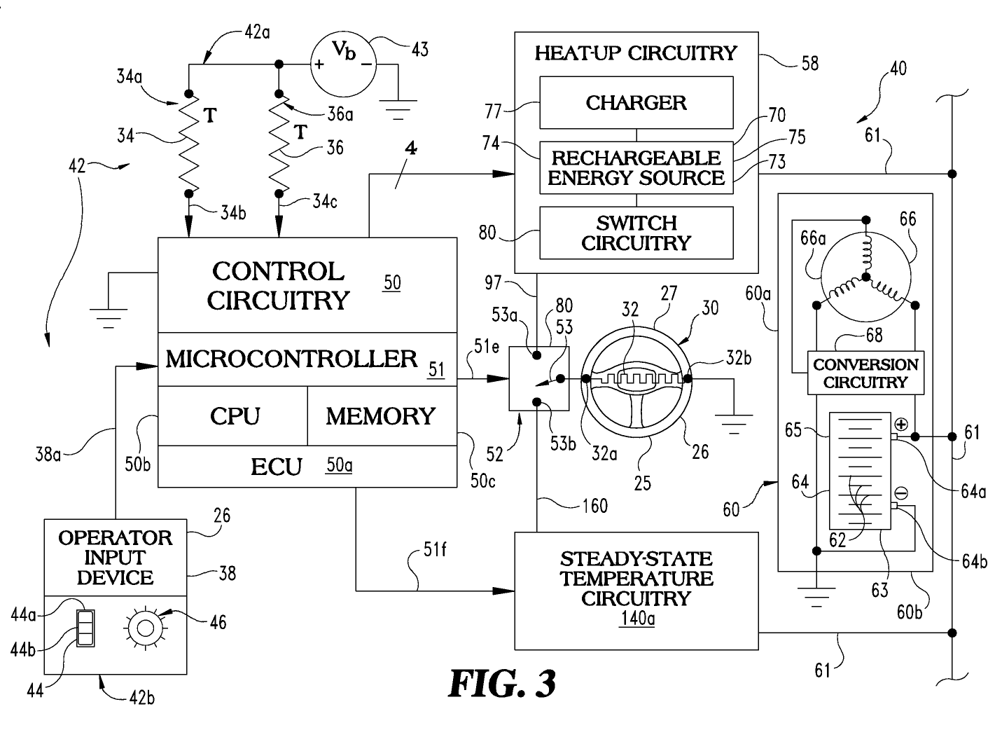

FIG. 1 further includes a schematically illustrated heating element 32 structured relative to steering wheel 30 to be in thermally conductive contact therewith and provide for selective heating of steering wheel 30. To monitor the temperature of steering wheel 30 as it is warmed or heated by heating element 32 is temperature sensor 34 that is also in thermally conductive contact with steering wheel 30. The temperature of steering wheel 30 as measured with temperature sensor 34 is represented as Temperature (T) that operates as an independent variable with respect to certain mathematical relationships described hereafter in connection with subsequently numbered figures. Also included is another temperature sensor 36 that is positioned to determine ambient air temperature within occupant compartment 24 of vehicle 22 that is represented by the variable Ambient Temperature (AT) herein. When vehicle 22 has not been operated for a given period of time, AT becomes representative of the starting temperature of steering wheel 30 prior to any heating. Heating system 20 includes heating circuitry 40 schematically represented in FIG. 1 and designated by reference numeral in FIGS. 3-5. Heating of steering wheel 30 by heating element 32 in response to heating circuitry 40 can be activated and halted in response to another type of vehicle control 26 (besides steering wheel 30) that is more particularly configured as an operator input device 38. While no connections are shown between schematic heating circuitry 40 and heating element 32, temperature sensor 34, temperature sensor 36, or operator input device 38 to preserve clarity, various particulars concerning the same are detailed in FIGS. 3-5 as described after FIG. 2.

Referring additionally to FIG. 2, heating element 32 is structured to warm steering wheel 30 when it is uncomfortably cold as activated and deactivated with operator input device 38. Heating element 32 is of an electrically resistive type that is structured in the form of mesh 33 of an appropriate metallic alloy as illustrated and designated in a cut-away of FIG. 2. Alternative or additional heating element configurations include a straight, wound, or coiled wire of an appropriate metallic alloy; a metallic ribbon; a hollow tubular type; a ceramic heating element; a quartz heating element, certain types of electrically resistive polymer, certain types of composite materials, or the like. In other implementations of heating system 20, steering wheel 30 utilizes more than one heating element 32. Yet other forms of the heating system 20 include one or more heating elements 32 positioned to heat a different candidate for vehicle device 25 besides steering wheel 30; provide heating elements for more than one form of vehicle device 25 to as many as all of the different vehicle device 25 types designated inside occupant compartment 24; provides a heating element for one or more of windows 29, mirror 29d, and camera 29e; provides heating elements and support for all forms of vehicle device 25 designed in addition to steering wheel 30, and/or otherwise position one or more heating elements to warm a different heating element 25 not designated with greater specificity.

In another cut-away of FIG. 2, temperature sensor 34 is shown positioned between covering layer 31a and structural support 35, and is further designated as a type of thermistor 34a represented by a widely-used symbol for the same—namely a resistor symbol with the letter “T” positioned nearby. Referring additionally to FIG. 3, temperature sensor 36 is also further designated as a type of thermistor 36a being represented by the same type of symbol as thermistor 34a. Each thermistor 34a and thermistor 36a is a passive, two-terminal device of either a Positive Temperature Coefficient (PTC) type for which electrical resistance increases with rising temperature or of a Negative Temperature Coefficient (NTC) type for which electrical resistance decreases with rising temperature. Accompanying conditioning circuitry (not shown) and input signal processing from thermistor 34a or thermistor 36a is provided appropriate to whether it is the PTC or NTC type. NTC thermistors find use in the detection temperature T over a range likely to be of interest and have found use in vehicle applications. Unlike an NTC thermistor, certain electrically resistive PTC thermistor devices can be structured to deliver heat rapidly when resistance and temperature of the device are relatively low, but gradually reduce the heat delivered as temperature rises and correspondingly resistance increases up to a set-point where the heat provided effectively results in leveling-off at a target temperature, designated as a Target temperature Level (TL) herein. Such a device operates as a self-limiting heating element—effectively replacing two components with one. Alternatively, temperature sensor 34 and/or temperature sensor 36 may be in the form of a thermocouple or other device based on the thermoelectric effect (e.g. the Peltier effect and/or Seebeck effect), a linear Resistance Temperature Detector (RTP) of the wire-wound type, a linear RTP of the thin film type, any of several different kinds of temperature sensing semiconductor device, or other such other device to sense or detect temperature as would occur to those of ordinary skill in the pertinent technical art(s)/field(s).

Specifically referring to FIG. 3, heating circuitry 40 of heating system 20 is further illustrated including: monitoring circuitry 42, control circuitry 50, heat-up circuitry 58 (inclusive of rechargeable energy source 70, charger circuitry 77, and switch circuitry 80 inclusive of connection switch 52), vehicle power supply 60, and steady-state temperature control circuitry 140a; and also further details heating element 32. Heating element 32 is illustrated as a two-terminal device schematically represented by a symbol resembling a repeating square wave pattern that finds widespread use in the pertinent technical art(s)/field(s). Electrical input terminal 32a of heating element 32 is opposite electrical grounded terminal 32b of heating element 32. Electrical grounded terminal 32b is electrically grounded and electrical input terminal 32a is electrically coupled to common contact 53 of connection switch 52. Among other things, monitoring circuitry 42 supplies various input signals to control circuitry 50. Monitoring circuitry 42 includes temperature input circuitry 42a and operator input circuitry 42b. Temperature input circuitry 42a includes temperature sensor 34, thermistor 34a, temperature sensor 36, thermistor 36a, and a biasing DC voltage source 43. The negative terminal of DC voltage source 43 is electrically grounded. The positive terminal of DC voltage source 43 is electrically coupled to one terminal of each of thermistors 34a and 36a such that they share a common electrical node biased to the output of DC voltage source 43 designated as DC voltage “Vb” herein. Depending on the type and nature of temperature sensors 34 and 36, temperature input circuitry 42a may include various conditioning circuitry and components external to control circuitry 50 and/or internal to control circuitry 50 to provide for a digitized value of temperature T or other format and/or processing suitable to utilize temperature T in the manner described hereafter. In one particular arrangement of heating circuitry 40, thermistor 34a and thermistor 36a are each of the NTC type so that resistance decreases with increasing temperature. In this arrangement, thermistor 34a is coupled to a common resistor at an electrical node common to input 34b with the other terminal of the common resistor being electrically grounded to form a voltage divider. This common resistor is selected to be suitably insensitive to temperature T compared to thermistor 34a with an electrical resistance value appropriate to provide a voltage at input 34b of sufficient resolution and range to represent temperature T in the manner further described hereafter. Control Circuitry 50 may include this standard resistor or it may be provided externally (not shown explicitly in either instance). In one implementation of heating circuitry 40, control circuitry 50 is responsive to the voltage supplied at input 34b from the voltage divider to convert it to a digital format or otherwise processes it in a manner suitable to represent temperature T Likewise, a common resistor of appropriate resistance and temperature insensitivity is electrically grounded at one terminal and coupled to thermistor 36a at the other terminal to form an electrical node common to input 34c to control circuitry 50 and define a corresponding voltage divider. Control circuitry 50 can be configured to utilize the voltage from input 34c in a manner like that described in relation to input 34b such that it is suitable to represent the ambient temperature AT in the manner described hereafter.

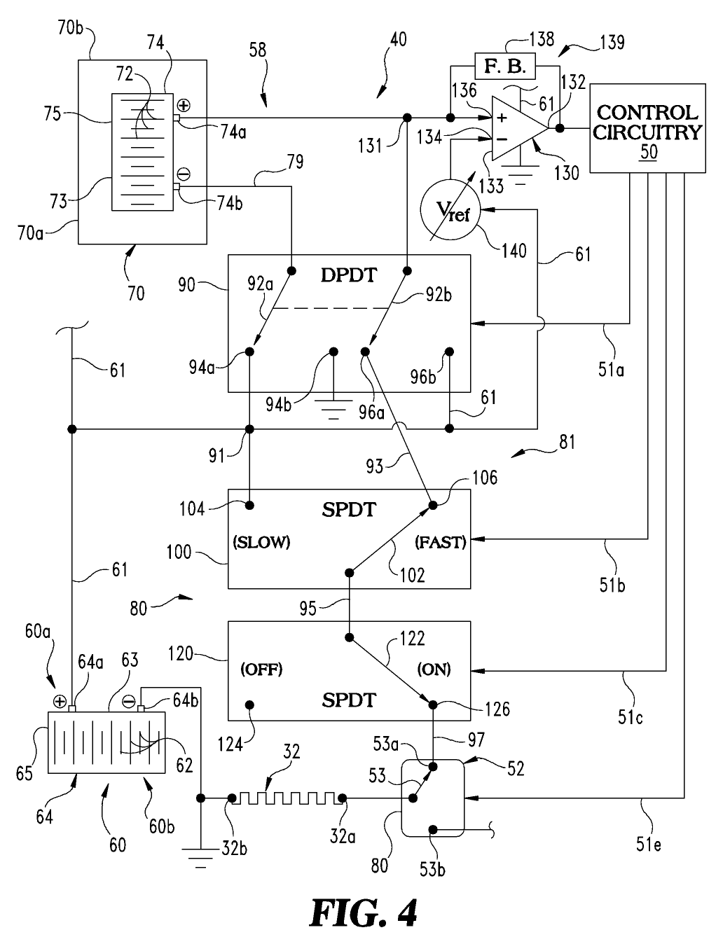

Operator input circuitry 42b includes operator input device 38. Operator input device 38 provides a switch 44 of the pushbutton type that toggles between three different states, transitioning from one to the next with each subsequent push by the operator. Upon start-up of vehicle 22, heating circuitry 40, control circuitry 50, and operator input device 38 begin in a first state absent any operator manipulation of switch 44 unless vehicle 22 was stopped in the third state to be more specifically described hereafter. In this first state, switch 44 is unlit, and heating of steering wheel 30 is inactive or halted (heating inactive state) unless subject to the overriding third state. If the operator pushes switch 44 once after start-up of vehicle 22, then it emits one color of light from Light Emitting Diode (LED) 44a and signals control circuitry 50 to activate heating of the steering wheel 30 with heating system 20 just a single time—effectively transitioning from the first state to a second state. This second state (single heating state) for steering wheel 30 is reset to the inactive state (first state) whenever vehicle 22 is stopped and restarted—that is it returns to the first state (heating inactive state). If the operator pushes switch 44 a second time after start-up of vehicle 22, then it emits a different color of light from LED 44b than the color emitted by LED 44a and transitions from the second state to a third state. In this third state, heating of steering wheel 30 is performed automatically whenever vehicle 22 is started and temperature T of steering wheel 30 (as gathered with thermistor 34a) is less than or equal to an Auto-start temperature Level (AL) selected with rotary dial 46 (automatic heating state). Dial 46 may be a form of potentiometer, rheostat, multi-position switch, or other device suitable to convey the automatic threshold level AL to control circuitry 50. This automatic heating state reactivates every time vehicle 22 is stopped and re-started, automatically emitting light from LED 44b upon start-up to inform the vehicle operator that the third state (automatic heating state) is active. However, pushing the switch 44 again without stopping vehicle 22 reestablishes the first state during which heating of steering wheel 30 is inactive and switch 44 is unlit. Provided vehicle 22 is not stopped, pushing switch 44 yet again transitions to the second state (single heating state), and still another time transitions to the third state (automatic heating state), and so on. Control circuitry 50 receives information from operator input device 38 via input 38a to track which of the three states currently applies, and also monitors whenever vehicle 22 stops in relation to the applicable state to determine whether to the next start-up of vehicle 22 will be in the first state (heating inactive state) or the third state (automatic heating state). Upon determining a given state is applicable, control circuitry 50 initiates appropriate action by the balance of heating circuitry 40 as appropriate—particularly directing any change as to the status of switch circuitry 80 as further described in connection with FIG. 4 hereafter.

Control circuitry 50 includes various circuits to: detect, receive, and condition input signals in an analog or digital format; generate, transmits, and condition output signals in an analog or digital format; and otherwise perform in a manner suitable to operate in the manner described hereinafter. Control circuitry 50 further includes Engine Control Unit (ECU) 50a that comprises various circuits and architecture to control a corresponding engine and/or drive train of vehicle 22 and optionally at least some other aspects of operation of vehicle 22. In one form of heating circuitry 40, control circuitry 50 is completely provided by ECU 50a, while in others control circuitry 50 and ECU 50a are separate and independent from one another. In still other forms, control circuitry 50 and ECU 50a may overlap in some respects. In yet a further form, ECU 50a is absent. Control circuitry 50 further includes microcontroller 51 equipped with a Central Processing Unit (CPU) 50b and corresponding memory 50c. Microcontroller 51 typically includes digital inputs and outputs, and analog inputs and outputs, one or more interrupt inputs, one or more waveform generation outputs, one or more timers, one or more analog-to-digital converters (ADCs), one or more digital-to-analog converters (DACs), one or more serial and/or parallel communication buses, and such other circuitry suitable to operate in the manner described herein. Microcontroller 51 includes the capability to process, store, and communicate information in accordance with specified operating logic—such operating logic may be in the form of analog circuitry; digital circuitry; hardwired, firmware, or software programming instructions; or a combination of any of the foregoing. CPU 50b can be of a reduced instruction set computing (RISC) architecture, a complex instruction set computing (CISC) architecture, a parallel and/or serial instruction pipelining architecture, a multiprocessing and/or multitasking architecture, or such other architecture as would occur to those of ordinary skill in the art. Memory 50c can be of a single type or different types. Such types may include various nonvolatile varieties such as read-only memory (ROM) that can be programmed only a single time (PROM), electrically erasable PROM that can be reprogrammed, but usually one for a limited number of times (EEPROM), or flash memory; or volatile types such as dynamic random access memory (DRAM), static random access memory (SRAM), and a high speed content addressable type (cache), among many other more exotic types and numerous variants thereof. In one arrangement of microcontroller 51, a nonvolatile portion of memory 50c, such as a flash, PROM, or EEPROM stores any operating logic provided in the form of programming instructions executable by CPU 50b. In a different arrangement for which at least some of the operating logic is in the form of programming instructions, memory 50c also includes a content-addres sable volatile cache to pre-fetch such instructions and/or execute alternative instruction pipelines; volatile DRAM or SRAM for intermediate, temporary storage of data and/or such instructions; and one or more nonvolatile semiconductor memory varieties for the long-term storage of such instructions and certain types of other information. Control circuitry 50 is responsive to monitoring circuitry 42 (inclusive of temperature input circuitry 42a and operator input circuitry 42b) to execute its operating logic in response and generate a number of outputs, including: control output 51f to steady-state temperature control circuitry 140a, four control outputs 51a, 51b, 51c, and 51d to circuitry 58, and one control output 51e to connection switch 52 of switch circuitry 80.

FIG. 3 also illustrates vehicle power supply 60 that is alternatively designated as DC electric power source 60a and DC voltage supply 60b. Vehicle power supply 60 provides DC voltage that is nominally in a range between approximately 12-15 volts DC. Vehicle power supply 60 includes a three-phase AC generator 66 in the more specific form of a three-phase AC vehicle alternator 66a that provides a three-phase AC output from its three stator coils in response to the application of rotary mechanical power to a field coil rotor (not shown). A vehicle engine is typically the prime mover that provides the rotary mechanical power to turn or drive this rotor. The three-phase AC output of the stator is input to conversion circuitry 68. Conversion circuitry 68 rectifies the three-phase AC electric output typically with six power diodes arranged in a standard way to provide a DC voltage output on DC voltage bus 61. Because little or no filtering or regulation may be associated with this DC voltage output, a periodic ripple rides on top of a DC offset voltage—resulting in a voltage magnitude that varies with the frequency of the ripple, but never changes polarity—thus such output readily qualifies as a DC voltage. As a result of this ripple, the voltage magnitude may decrease on an approximately periodic basis by 5%-10% relative to the peak magnitude with the ripple. In addition, three power diodes each electrically coupled to a different phase are input to a voltage regulator that provides a highly regulated output voltage to the field coil of the rotor via slip ring electrical coupling for the three-phase AC vehicle alternator 66a form of three-phase AC generator 66. Conversion circuitry 68 also typically provides for ignition of vehicle 22 and/or one or more lamps related to three-phase AC vehicle alternator 66a operation. Vehicle power supply 60 further includes a rechargeable electric power source 63 more specifically in the form of a rechargeable electrochemical energy storage device 64 comprised of one or more electrochemical cells 62 arranged as rechargeable vehicle supply battery 65. Positive terminal 64a (an “anode” type of electrode of vehicle supply battery 65) is electrically coupled to the same electrical node common to DC voltage bus 61. Conversion circuitry 68 and negative terminal 64b (a “cathode” type of electrode of vehicle supply battery 65) are electrically grounded. In another form, a permanent magnet type of alternator (PMA) is utilized instead. In still another form, generator 66 is a motor/generator configuration used in a hybrid vehicle application that electrically recovers brake energy, among other things. In yet another form, generator 66 is of a single-phase type or is of a poly-phase type with more than three phases and includes corresponding modification of conversion circuitry 68 to provide a DC voltage output on DC voltage bus 61 suitable to operate heating system 20 in the manner described herein.

With heating element 32 being electrically grounded at grounded terminal 32b, its receipt of electric power to generate heat at a given level depends on the electrical characteristics presented to it through connection switch 52 (included in switch circuitry 80). More specifically, input terminal 32a of connection switch 52 is electrically coupled to common contact 53 of connection switch 52. In response to appropriate signaling from control circuitry 50 on control output 51e, connection switch 52 toggles common contact 53 between electrical coupling with contact 53a and contact 53b. When common contact 53 of connection switch 52 electrically couples with contact 53a, heat-up circuitry 58 is electrically connected to contact 53a via electrical coupling 97, which in turn electrically connects to input terminal 32a of heating element 32. In contrast, when common contact 53 of connection switch 52 electrically couples with contact 53b, steady-state temperature control circuitry 140a is electrically connected to contact 53b via amplified output 160, which in turn electrically connects to input terminal 32a of heating element 32. Connection switch 52 is an electromechanical relay, a solid-state relay, a transistor-based solid-state switch, or another switching device suitable to operate in the manner described. What constitutes signaling appropriate to cause common contact 53 to change electrical coupling between contact 53a and contact 53b depends, at least in part, on the specific variety of connection switch 52. In some forms, common contact 53 electrically couples with contact 53a or contact 53b depending on a binary logic level of a signal on control output 51e with electrical coupling between common contact 53 and one of contact 53a and contact 53b occurring while the signal is “true” and coupling between common contact 53 and the other of contact 53a and contact 53b occurring while the signal is “false”—where any change in a signal characteristic could be used to distinguish between true and false. In other forms, a pulse on control output 51e of a certain character causes common contact 53 to toggle between electrical coupling with contact 53a and contact 53b—where such character could relate to pulse magnitude, pulse width/duration, time separating pulses, a combination of these, or as otherwise would occur to those of ordinary skill in the art. In still different forms, the signal causing common contact 53 to change electrical coupling from one to the other as between contact 53a and contact 53b relates to a particular signal waveform, change in frequency, an amplitude variation, a combination of the foregoing, or as otherwise would occur to those of ordinary skill in the art. Further, in certain variants, it should be recognized that a signal on control output 51e causing common contact 53 to switch from contact 53a to contact 53b may be different than that causing common contact 53 to switch from contact 53b to contact 53a.

Referring additionally to FIG. 4, heat-up circuitry 58 includes rechargeable energy source 70 that is alternatively designated as DC rechargeable supply 70a and DC rechargeable source 70b. Rechargeable energy source 70 is a type of DC voltage source 73 that is more particularly a variety of rechargeable electrochemical energy storage device 74. Rechargeable energy source 70 includes positive terminal 74a and negative terminal 74b that likewise are electrical coupling sites for its alternative designations as DC rechargeable supply 70a and DC rechargeable source 70b, its role as a type of DC voltage source 73, and more particularly as a variety of rechargeable electrochemical storage device 74. Even more specifically, rechargeable electrochemical energy storage device 74 is depicted as rechargeable battery 75 comprised of one or more electrochemical cells 72. Rechargeable battery 75 includes two external electrodes of opposite polarity that correspond to positive terminal 74a (an anode of rechargeable battery 75) and negative terminal 74b (a cathode of rechargeable battery 75). In certain forms, the one or more electrochemical cells 72 of rechargeable energy source 70 are of the Lead-Acid (LA), Lithium-Ion (Li-ion), Lithium-Sulfur (Li—S), Nickel-Cadmium (Ni-Cad), or Nickel-Metal-Hydride (NiMH) type. The Li-ion cell type extends to both the Li-ion Polymer (LiPo) variety and the Li-ion non-polymer variety. Furthermore the Li-ion cell type includes, but is not limited to, the following Li-ion subtypes identified by composition: Lithium Cobalt Oxide (LiCoO₂), Lithium Iron (Ferrous) Phosphate (LiFePO₄ or LFP), Lithium Manganese Oxide (LiMn₂O₄, Li₂MnO₃, or more generally LMO), Lithium Nickel Manganese Cobalt Oxide (LiNiₓMn_{y}Co_{z}O₂ or NMC), Lithium Nickel Cobalt Aluminum Oxide (LiNiCoAlO₂ or NCA), or Lithium Titanate (Li₄Ti₅O₁₂ or LTO) to name some representative examples. The NiMH-type of electrochemical cells 72 include, but are not limited to, the NiMH subtypes with electrochemistry based on a negative electrode composition in which the metal “M” is an intermetallic corresponding to AB₅ (where A is a rare earth mixture of lanthanum, cerium, neodymium, and/or praseodymium, and B is nickel, cobalt, manganese, or aluminum) or AB₂ (where A is titanium or vanadium, and B is zirconium or nickel, modified with chromium, cobalt, iron, or manganese)—to mention some representative examples. In certain applications, the maximum DC voltage output sought from rechargeable energy source 70 is as great as possible that still allows for recharging at the DC voltage output by the vehicle power supply 60 without resorting to any technique to increase the magnitude of such DC voltage. In some of these applications, a voltage level to perform “float” charging and/or overvoltage charging stages require a charging voltage magnitude that exceeds the maximum DC voltage output of rechargeable energy source 70 by a specified amount. Accordingly, certain arrangements of rechargeable energy source 70 are comprised of electrochemical cells 72 each of the same electrochemistry configured in series in a quantity sufficient to provide a maximum DC voltage that remains below the minimum DC voltage output expected from DC voltage bus 61 of vehicle power supply 60 by an amount required to facilitate charging. In alternative arrangements, rechargeable energy source 70 is comprised of electrochemical cells 72 in series that approach or exceed the DC voltage output of vehicle power supply 60 to the extent that one or more techniques are employed to increase the magnitude of such DC voltage as is further described in connection with charger circuitry 77 hereafter. While the DC voltage output of such arrangements depends on the quantity of electrochemical cells 72 in series, the collective capacity thereof is a more complex function influenced primarily by the amount of usable electrode material in the electrochemical cells 72, cell temperature, rate of discharge, and the like. Another implementation of rechargeable energy source 70 is of the Valve-Regulated Lead-Acid (VRLA) variety that correspondingly is comprised of one or more electrochemical cells 72 of the sealed, LA type. In one refinement of this implementation, rechargeable energy source 70 (and correspondingly, rechargeable battery 75) incorporates multiple LA electrochemical cells 72 of the Absorbed Glass Mat (AGM) subtype of VRLA variety. Typically, this AGM subtype includes, among other things, a suitable fiberglass mesh between cell plates that absorbs electrolyte, providing for at least partial immobilization of it in comparison to a flooded, wet cell LA battery. In another refinement, multiple electrochemical cells 72 of rechargeable energy source 70 are provided of the gelled subtype of VRLA. In one form, this gelled subtype includes silica particles dispersed throughout the electrolyte to impart a gel-like or putty-like consistency that at least partially immobilizes the electrolyte compared to the liquid phase of the electrolyte in a flooded, wet cell LA battery. In one particular form of the present application, the configuration of one or more electrochemical cells 72 of rechargeable energy source 70 provides a maximum DC output voltage of approximately 9 volts. In another form, this configuration provides a maximum DC output voltage approximately the same as that of vehicle supply battery 65. In yet other forms, such maximum DC output voltage is less than 9 volts. In different forms, such maximum DC output voltage is more than 12.6 volts.

Heat-up circuitry 58 also includes charger circuitry 77 structured to facilitate charging of the one or more electrochemical cells 72 of rechargeable battery 75 in response to detecting depletion thereof. In certain implementations, charger circuitry 77 is based on the quantity, arrangement, and specific electrochemical characteristics of such electrochemical cells 72—being structured to perform recharging in accordance with a well-defined profile for the particular configuration of electrochemical cells 72, while monitoring various characteristics of the same (e.g. temperature(s) of the one or more cells 72, electric current discharge history, voltage history during discharge, or the like) to reduce the likelihood of incurring damage thereto. In some of these implementations, the profile encompasses multiple stages, while others may be of only a single-stage variety. In one instance directed to the Li-ion variety of electrochemical cells 72, the profile performed by charger circuitry 77 includes a constant current stage followed by a constant voltage stage, and can include a balancing stage in between to the extent charge balancing between different electrochemical cells 72 has not been previously established. In a variety of rechargeable battery 75 incorporating NiMH cells, charger circuitry 77 performs: (1) a fast charging stage that terminates based on detection of a certain voltage drop and/or a certain temperature increase indicating rechargeable battery 75 is fully charged and (2) a trickle charging stage performed at a fixed, low electric current magnitude relative to the other stage to maintain the charge and counteract any self-discharge. As a single stage alternative for NiMH-based configurations, only trickle charging is performed. For a different form of rechargeable battery 75 (and correspondingly rechargeable energy source 70) comprised of the LA type of electrochemical cells 72 in a deeply discharged state, one kind of charging profile includes three stages: (1) a bulk charging stage that applies a generally constant electric current until the battery is approximately 70%-80% charged, (2) boost charging stage (absorption/topping charging) that applies a voltage too high for the battery to endure indefinitely without the risk of damage (an overvoltage) but tolerable in the short-term until the battery is about 95% charged with electric current gradually decreasing until it falls below a level triggering the next stage, and (3) a float charging stage (preservation charging) that applies a constant voltage the battery can tolerate indefinitely (compared to the overvoltage) to fulfill the last 5% of charge capacity and otherwise counteract self-discharge. In still another instance, charging may be performed in only a single stage of the float or trickle charging variety, such as the preservation charge approach common to the way an LA type of vehicle supply battery 65 is charged by vehicle power supply 60. It should be appreciated that the specific recommendations for charging rechargeable battery 75 can vary greatly with the electrochemical characteristics of electrochemical cells 72 and the like with the particulars of charger circuitry 77 being structured accordingly.

In certain implementations of heat-up circuitry 58, charger circuitry 77 is partially or completely embedded in the same device containing the one or more electrochemical cells 72 or otherwise defining the rechargeable energy source 70. In still other forms of the heat-up circuitry 58, charger circuitry 77 is absent—particularly in those cases for which recharging is suitably performed using the DC voltage output from vehicle power supply 60 alone in a single charging stage. For those forms of rechargeable energy source 70 including electrochemical cells 72 arranged in series to provide a maximum voltage too high to be recharged without utilizing techniques to increase the DC voltage output by vehicle power supply 60, then charger circuitry 77 includes circuitry directed to converting such DC voltage to a higher level adequate to perform recharging in view of such maximum voltage. As part of or separate from charger circuitry 77, certain forms of heat-up circuitry 58 include one or more protective diodes or other unidirectional electric current flow devices to prevent reverse flow of electric current through any of the one or more electrochemical cells 72 contained in rechargeable energy source 70, a sensor to detect excessive temperature of rechargeable battery 75 to halt use of rechargeable battery 75 or otherwise adjust operation of heat-up circuitry 58 accordingly, and/or such other protective measures as would occur to those of ordinary skill in the art.

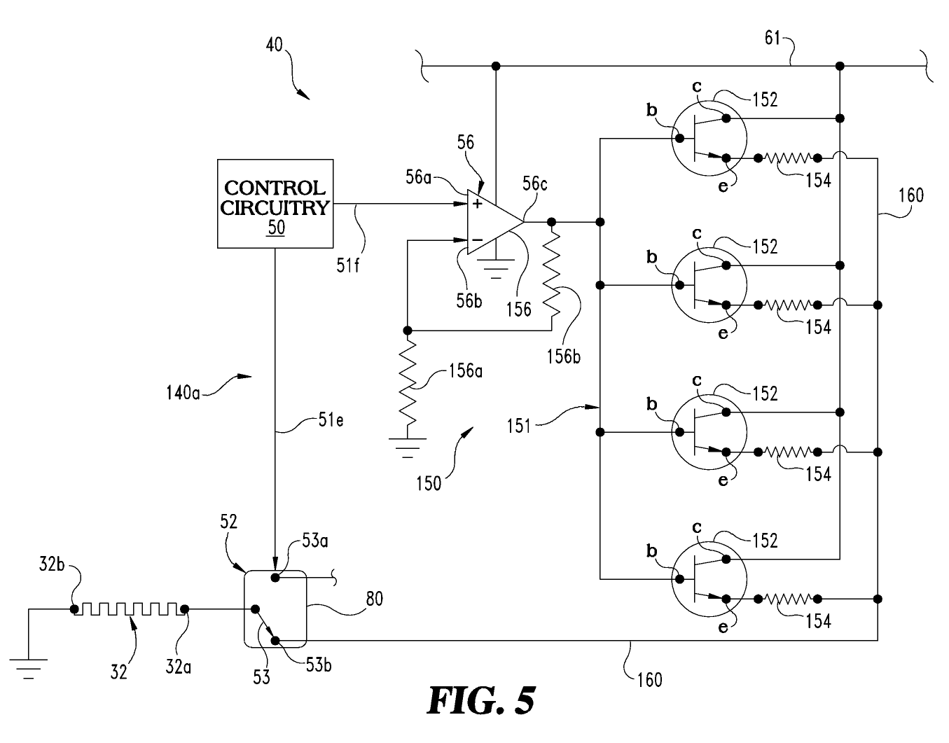

Referring to both FIGS. 3 & 4, heat-up circuitry 58 facilitates the selective application of two different modes for heating-up steering wheel 30 with heating element 32. For both of these modes, common contact 53 is electrically coupled to contact 53a of connection switch 52 that correspondingly provides electrical connection to heat-up circuitry 58 through electrical coupling 97. Let the DC voltage output of vehicle power supply 60 be the “DC supply voltage” and that of rechargeable energy source 70 be the “DC source voltage.” Provided that rechargeable energy source 70 has not depleted its stored electric charge past a certain point, it is used in conjunction with vehicle power supply 60 to define the first of these two modes for heating-up steering wheel 30 with heating element 32. For this first mode, vehicle power supply 60 and rechargeable energy source 70 are electrically coupled together so that the DC voltage drop across heating element 32 is approximately the sum of the DC supply voltage and the DC source voltage (that is the voltages of vehicle power supply 60 and rechargeable energy source 70 are additive). The DC supply voltage and the DC source voltage added together raises the magnitude of electric current flow through heating element 32 compared to either the vehicle power supply 60 or the rechargeable energy source 70 without the other. Indeed, for voltage “V” and current “I” of the DC type, and a relatively fixed resistance “R” of heating element 32, the power P dissipated by heating element 32 is expressed by the relationship P=V²/R. As a result, doubling the voltage V results in an increase in power P in proportion to the square of V. So, if V is doubled, becoming 2V, then power P=(2V)²/R=4V²/R; such that power P increases by a factor of four (4). Correspondingly, if DC supply voltage is approximately equivalent to DC source voltage, and the sum of the two is applied across heating element 32, then power P increases by approximately a factor of four (4). With continued use, rechargeable energy source 70 eventually degrades as the energy available from it is depleted. Not infrequently, a certain drop in the magnitude of DC source voltage indicates depletion of rechargeable energy source 70 as further described in connection with detection circuitry 130 depicted in FIG. 4. While higher power P results during the first mode of operation provides for a relatively fast rate for heating-up steering wheel 30, the eventual depletion of rechargeable energy source 70 ultimately limits the duration of the first mode. Detection circuitry 130 determines when such depletion has occurred as specifically illustrated in FIG. 4. Upon detection of depletion with circuitry 130, heating-up of steering wheel 30 can continue if steering wheel 30 has not yet reached its Target temperature level TL by triggering the second mode of heating-up steering wheel 30 in place of the first mode. The implementation of this second mode includes the reconfiguration of electrical connectivity of heating element 32, vehicle power supply 60, and rechargeable energy source 70 relative to the first mode. In this second mode, the heating-up of steering wheel 30 continues by energizing heating element 32 with the DC supply voltage from vehicle power supply 60 as it is ultimately driven by the engine or other prime mover of vehicle 22—absent the DC source voltage because of the depletion of rechargeable energy source 70. This reconfiguration for the second mode also provides the DC supply voltage for recharging rechargeable energy source 70 via charger circuitry 77 or directly for those arrangements in which charger circuitry 77 is absent. Without the contribution of the DC source voltage from rechargeable energy source 70, the power P available for heating element 32 is reduced—becoming approximately one-fourth (¼th) of what it was when the DC supply voltage and the DC source voltage are approximately the same based on the relationship P=V²/R. As a result, this second mode heats-up heating element 32 and correspondingly steering wheel 30 more slowly compared to the first mode—in other words, the heating rate of the first, “fast” mode is quicker than the heating rate of the second, “slow” mode. Likewise, temperature T of steering wheel 30 increases more rapidly during the first/fast mode than during the second/slow mode. Accordingly, the first/fast mode increases temperature T at a first nonzero rate and the second/slow mode increases the temperature T at a second nonzero rate less than the first nonzero rate. In comparison, signaling on control output 51e electrically connects heating element 32 to steady-state temperature control circuitry 140a in place of heat-up circuitry 58. Steady-state temperature control circuitry 140a corresponds to a third mode for providing heat to steering wheel 30 with heating element 32 to maintain steering wheel temperature T at approximately a target temperature level TL, which is further described in connection with FIG. 5 hereafter.

Under the direction of control circuitry 50, switch circuitry 80 provides two alternative circuits including heating element 32, vehicle power supply 60 and rechargeable energy source 70 as perhaps best illustrated in FIG. 4. One of these circuits implements the first/fast mode of operating heat-up circuitry 58 and the other of these circuits implements the second/slow mode of operating heat-up circuitry 58; where both the first/fast and second/flow modes of operation were introduced previously. Switch circuitry 80 includes electrically interconnected switches 81 each of an electromechanical relay variety, a solid-state relay variety, a transistor-based or other solid-state switch variety, or may be otherwise configured as would occur to those of ordinary skill in the art. In the depicted example, switches 81 more specifically include DPDT relay 90, SPDT relay 100, and SPDT relay 120. DPDT relay 90 includes common contact 92a electrically connected to negative terminal 74b of rechargeable energy source 70 by electrical coupling 79. DPDT 90 also includes an electrical coupling between common contact 92b and positive terminal 74a of rechargeable energy source 70 that corresponds to electrical node 131. DPDT relay 90 further includes contact 94a and contact 94b, and contact 96a and contact 96b. Common contact 92a electrically couples with contact 94a or contact 94b, and common contact 92b electrically couples with contact 96a or contact 96b. More specifically, common contact 92a makes an electrical connection with contact 94a when common contract 92b makes an electrical connection with contact 96a as illustrated in FIG. 4 to define a first electrical connection configuration of DPDT relay 90. Alternatively, common contact 92a makes an electrical connection with contact 94b when common contract 92b makes an electrical connection with contact 96b (not shown) to define a second electrical connection configuration of DPDT relay 90. DPDT relay 90 alternates between this first electrical connection configuration and this second electrical connection configuration in response to the appropriate signaling by control circuitry 50 through control output 51a—where a few nonlimiting examples of such signaling were previously described as to the signaling by control circuitry 50 via control output 51e to alternate common contact 53 of connection switch 52 between electrical connection with contact 53a or electrical connection with contact 53b.

SPDT relay 100 includes common contact 102, contact 104, and contact 106. SPDT relay 100 is responsive to appropriate signaling by control circuitry 50 via control output 51b to alternate common contact 102 between electrical connection with either contact 104 (not shown) or contact 106 (shown in FIG. 4). Correspondingly, SPDT relay 100 has two different electrical configurations. SPDT relay 120 also has two possible configurations. SPDT relay 120 includes common contact 122, contact 124, and contact 126. SPDT relay 120 is responsive to appropriate signaling by control circuitry 50 via control output 51c to alternate common contact 122 between an electrical connection with either contact 124 (not shown) or contact 126 (shown in FIG. 4).

Heat-up circuitry 58 defines an electrical interconnection between DC voltage bus 61, positive terminal 64a of vehicle supply battery 65, contact 94a of DPDT relay 90, contact 96b of DPDT relay 90, and contact 104 of SPDT relay 100—where such interconnection corresponds to DC voltage supply node 91. During operation, DC voltage bus 61 imparts a positive electric potential (voltage) to DC voltage supply node 91 relative to electrical ground. Negative terminal 64b, contact 94b of DPDT relay 90, and grounded terminal 32b of heating element 32 are electrically grounded corresponding to an electric potential (voltage) of approximately zero in relation to that at DC voltage supply node 91. Positive terminal 74a of rechargeable energy source 70 is electrically coupled to common contact 92b of DPDT relay 90 in correspondence to electrical node 131. Negative terminal 74b of rechargeable energy source 70 is electrically coupled to common contact 92a by electrical coupling 79, and common contact 92a electrically couples with contact 94a of DPDT relay 90, which in turn electrically interconnects with DC supply voltage node 91—so that negative terminal 74b of rechargeable energy source 70 electrically couples with positive terminal 64a of vehicle supply battery 65 and likewise DC voltage bus 61. As illustrated, common contact 92b is electrically coupled to contact 96a of DPDT relay 90 that is electrically coupled to contact 106 of SPDT relay 100 by electrical coupling 93. Common contact 102 is electrically coupled to contact 106 of SPDT relay 100 and is electrically connected to common contact 122 via electrical coupling 95. Common contact 122 of SPDT relay 120 electrically connects with contact 126 per as shown in FIG. 4. Contact 126 electrically connects to contact 53a through electrical coupling 97 and contact 53a electrically connects with input terminal 32a of heating element 32 via common contact 53 of connection switch 52. Accordingly, input terminal 32a of heating element 32, common contact 53, electrical coupling 97, contact 126, common contact 122, electrical coupling 95, common contact 102, contact 106, electrical coupling 93, contact 96a, common contact 92b, and positive terminal 74a all electrically interconnect with electrical node 131 in the FIG. 4 depiction. Per this depiction, vehicle power supply 60 (and correspondingly vehicle supply battery 65) is connected in series electrically with rechargeable energy source 70. More specifically the negative terminal 74b of rechargeable energy source 70 is electrically connected to positive DC supply voltage node 91 while the negative terminal 64b of vehicle power supply 60 is grounded—effectively stacking the DC source voltage imparted by rechargeable energy source 70 on top of the DC supply voltage imparted by vehicle power supply 60. Further, the interconnection of positive terminal 74a of rechargeable energy source 70 with input terminal 32a of heating element 32 at electrical node 131 through DPDT relay 90, SPDT 100, and SPDT 120 places the sum of the DC supply voltage of vehicle power supply 60 and the DC source voltage of rechargeable energy source 70 across heating element 32. In view of the interconnection of negative terminal 64b of vehicle power supply 60 and grounded terminal 32b of heating element 32 by way of electrical grounding, a first circuit is defined where vehicle power supply 60, rechargeable energy source 70, and heating element 32 are all coupled electrically in series such that the electrical current circulating through this first circuit is generally the same through heating element 32, rechargeable energy source 70, and vehicle power supply 60. The illustrated first circuit (or series circuit) of switch circuitry 80 implements the first/fast mode of heating-up steering wheel 30 with heating element 32 by imparting a DC voltage drop across heating element 32 that is greater than the DC supply voltage in general, and more specifically is approximately the sum of the DC supply voltage and the DC source voltage.

Heat-up circuitry 58 further includes detection circuitry 130 to determine whether performance of rechargeable energy source 70 indicates a state of depletion warranting recharging thereof in lieu of continued use. Such depletion corresponds to an operational state change of heating system 20 that often depends on the specifics of the one or more electrochemical cells 72 comprising rechargeable energy source 70 and/or potentially one or more other aspects thereof. In many applications, depletion detection is based on the DC source voltage falling below an identified threshold and/or decreasing a certain amount relative to one or more influential factors, such as temperature, signal noise, transient behavior, or the like. Alternatively or additionally, the recognition of depletion results from: identification of decreasing trends or patterns of DC source voltage, evaluation of the discharge history for rechargeable energy source 70, tracking power or capacity of rechargeable energy source 70, or the like. Detection circuitry 130 includes comparator 133 with noninverting input 136, inverting input 134, and output 132. Noninverting input 136 is electrically interconnected to electrical node 131 along with positive terminal 74a of rechargeable energy source 70 and common contact 92b of DPDT relay 90 so that comparator 133 receives a representation of the DC supply voltage from rechargeable energy source 70. Inverting input 134 of comparator 133 is electrically connected to adjustable voltage reference 140 to receive a voltage reference signal therefrom that is designated “Vref” herein. Comparator 133 delivers a binary signal to control circuitry 50 that is indicative of a comparison of Vref input to inverting input 134 to the DC source voltage input to noninverting input 136. If the DC source voltage from rechargeable energy source 70 is greater than Vref, then comparator 133 delivers a binary result from output 132 to control circuitry 50 that represents a “true” condition or equivalently a logical one. If the DC source voltage is less than or equal to Vref, then comparator 133 delivers a binary result from output 132 to control circuitry 50 that represents a “false” condition or equivalently a logical zero without feedback 138. Detection circuitry 130 monitors the DC source voltage via noninverting input 136 for comparison to the adjustable voltage reference Vref, and detects depletion of rechargeable energy source 70 that warrants recharging in lieu of continued use by generating a “false” binary result from output 132 when it is reached.

When detection circuitry 130 signals the depletion of rechargeable energy source 70 through output 132, control circuitry 50 responds by reconfiguring heating element 32, vehicle power supply 60, and rechargeable energy source 70 in the first circuit to a second circuit including heating element 32, vehicle power supply 60, and rechargeable energy source 70 with a different electrical connectivity than the first circuit. This second circuit implements the second/slow mode of heating-up steering wheel 30, while the first circuit implements the first/fast mode of heating-up steering wheel 30. More specifically, control circuitry 50 responds to the depletion detection by signaling DPDT relay 90 via control output 51a and SPDT relay 100 via control output 51b to change from the illustrated configuration of FIG. 4 to the alternative configuration. As a result, common contact 92a of DPDT relay 90 electrically couples with contact 94b that is electrically grounded, and negative terminal 74b of rechargeable energy source 70 is electrically grounded via electrical coupling 79. At the same time, common contact 92b of DPDT relay 90 electrically connects with contact 96b that is in turn electrically interconnected to DC supply voltage node 91. Furthermore, common contact 102 of SPDT relay 100 electrically connects to contact 104 that also is electrically coupled at DC supply voltage node 91. The configuration of SPDT relay 120 and connection switch 52 both remain the same for the first circuit and the second circuit. Common contact 122 of SPDT relay 120 is electrically coupled to DC supply voltage node 91 via electrical coupling 95, common contact 102, and contact 104—so that contact 126, electrical coupling 97, contact 53a, common contact 53, and input terminal 32a of heating element 32 are likewise electrically coupled together with DC supply voltage node 91. The resulting second circuit places heating element 32 across vehicle power supply 60 by virtue of the electrical connection between common contact 102 and contact 104 due to the reconfiguration of SPDT relay 100 relative to that shown in FIG. 4. This reconfiguration also causes the electrical grounding of negative terminal 74b of rechargeable energy source 70 and the electrical coupling of positive terminal 74a to DC voltage bus 61 of vehicle power supply 60. Accordingly, heating element 32, vehicle power supply 60, and rechargeable energy supply 70 are connected in parallel electrically—where each one of the three is electrically positioned between the same pair of electrical nodes with the same electric potential applied thereacross. Namely, DC supply voltage node 91 is electrically connected to positive terminal 64a of vehicle power supply 60, positive terminal 74a of rechargeable energy supply 70, and input terminal 32a of heating element 32, while grounded terminal 32b of heating element 32, negative terminal 64b of vehicle power supply 60, and negative terminal 74b of rechargeable energy source 70 are all electrically grounded. This second circuit applies DC supply voltage from DC voltage bus 61 across both heating element 32 and rechargeable energy source 70, which facilitates heating-up steering wheel 30 with heating element 32 at the DC supply voltage level albeit at a slower rate compared to the first circuit when rechargeable energy source 70 is in an un-depleted condition. Further, the second circuit facilitates recharging rechargeable energy source 70 with the DC supply voltage from vehicle power supply 60 either directly (as in the case of vehicle supply battery 65) or via charger circuitry 77 (not shown in FIG. 4).

For both the first/serial circuit to perform the first/fast mode of heating-up steering wheel 30 and the second/parallel circuit to perform the second/slow mode of heating-up steering wheel 30, the configuration of SPDT relay 120 remains the same. If control circuitry 50 transmits appropriate signaling through control output 51c to SPDT 120, it reconfigures so that common contact 122 is electrically coupled to contact 124 instead of contact 126. With the status of connection switch 52 remaining the same as shown in FIG. 4 (common contact 53 electrically coupled to contact 53a), the electrical coupling of common contact 122 with contact 124 electrically disconnects heating element 32 from any active circuitry because contact 126 terminates the electrical interconnection of heating element 32 through connection switch 52 in an open circuit. As long as the configuration of connection switch 52 is maintained with common contact 53 electrically coupled with contact 53a, this open circuit termination at contact 126 deactivates heating element 32 and correspondingly halts steering wheel heating. By halting steering wheel heating, this configuration of SPDT relay 120 in conjunction with the displayed configuration of connection switch 52 (common contact 53 electrically coupled to contact 53a) implements the inactive state that is selectable with operator input device 38. This inactive state can be implemented in response to the selection of the corresponding one of the three possible settings selectable with pushbutton switch 44 that does not light up. It should be appreciated that signaling SPDT relay 120 in this manner results in deactivation of heating element 32 irrespective of which of the two configurations of DPDT 90 or SPDT 100 apply per control circuitry 50 signaling along control output 51a or control output 51b.

FIG. 5 displays certain details concerning steady-state temperature control circuitry 140a that are selected and activated when temperature senor 34 of monitoring circuitry 42 detects or otherwise determines that temperature T of steering wheel reaches or attains the target temperature level TL. Upon the determination that temperature T reaches/attains target temperature level TL with control circuitry 50, connection switch 52 responds to signaling from control circuitry 50 via control output 51e to electrically disconnect heat-up circuitry 58 including the capability to perform either the first/fast mode or second/slow mode of heating-up steering wheel 30. This disconnection results from the electrical decoupling of common contact 53 with contact 53a. Instead, a reconfiguration of connection switch 52 occurs that establishes electrical coupling between common contact 53 and contact 53b. This reconfiguration of connection switch 52 causes input terminal 32a of heating element 32 to be electrically connected to amplified output 160 of steady-state temperature control circuitry 140a.

Depletion detection for rechargeable energy source 70 with detection circuitry 130 and the determination that temperature T attains target temperature level TL with temperature sensor 34 via monitoring circuitry 42 are two different ways an operational state change of heating system 20, its constituent heating circuitry 40, and/or corresponding operations takes place. For other forms of the present application an operational state change may be caused by other events, activities, or occurrences besides depletion detection or attainment of target temperature level TL.

Steady-state temperature control circuitry 140a defines a third circuit with heating element 32 operable to regulate the delivery of heat to steering wheel 30 in such a manner that approximately sustains its temperature T at the target temperature level TL. For this third circuit, control circuitry 50 monitors temperature T with monitoring circuitry 42 to determine whether there is any differential (error) between temperature T of steering wheel 30 and target temperature level TL of sufficient magnitude to cause an adjustment. Upon the determination to make such adjustment, Control circuitry 50 generates a modulated control signal structured to correct such differential and transmits the modulated control signal to amplifier circuitry 150 via control output 51f. This modulated control signal is more particularly a type of a PWM control signal. The duty cycle of this PWM control signal can be varied with respect to a predefined range, and is particularly selected to provide the amount of heat to steering wheel 30 that corrects the differential (error) to the extent it exceeds acceptable limits, or otherwise counteracts any detected level of heat loss or thermal dissipation from steering wheel 30 to approximately sustain temperature T at target temperature level TL. The PWM duty cycle of the modulated control signal increases when temperature T falls below target temperature level TL and decreases when temperature T is exceeds the target temperature level TL. The modulated control signal is provided through control output 51c to amplifier circuitry 150. Amplifier circuitry 150 includes preamplifier 56 implemented with an operational amplifier (op amp) and transistor array 151. The modulated control signal is transmitted from control circuitry 50 to noninverting input 56a of preamplifier 56 via control output 51f. The inverting input 56b of preamplifier 56 takes negative feedback from output 56c via voltage divider 57. Output 56c is connected to resistor 57b which is connected in series to resistor 57a which is in turn connected to ground. The inverting input 56b is connected between resistors 57a and 57b. Preamplifier 56 provides appropriate signal buffering, gain, and conditioning to generate a time-varying transistor drive signal representative of the modulated control signal that is sufficient to drive transistor array 151. Preamplifier 56 transmits this time-varying transistor drive signal from output 56c of preamplifier 56 to transistor array 151. In the described embodiment, transistor array 151 includes four (4) transistors 152 arranged to further amplify the transistor drive signal received from output 56c of preamplifier 56 Transistor array 151 receives the time-varying drive signal from output 56c of preamplifier 56 corresponding to the modulated control signal received by preamplifier 56 at noninverting input 56a. Other embodiments may have more or fewer transistors depending on design parameters and preferences. This time-varying drive signal from preamplifier 56 is applied to base b of each of the transistors 152 included in transistor array 151. The collector c of each transistor 152 is electrically coupled to DC voltage bus 61 as provided by vehicle power supply 60. A limiting resistor is electrically coupled between emitter e of each transistor 152 and output 160. Output 160 provides a time-varying energization signal for application to heating element 32 that corresponds to the PWM-type modulated control signal from control circuitry 50.

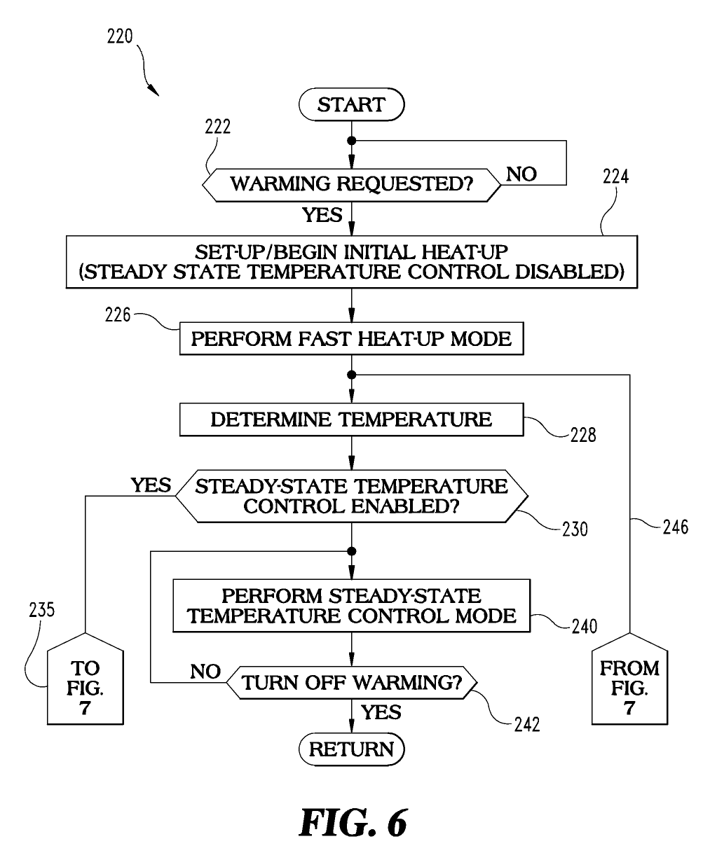

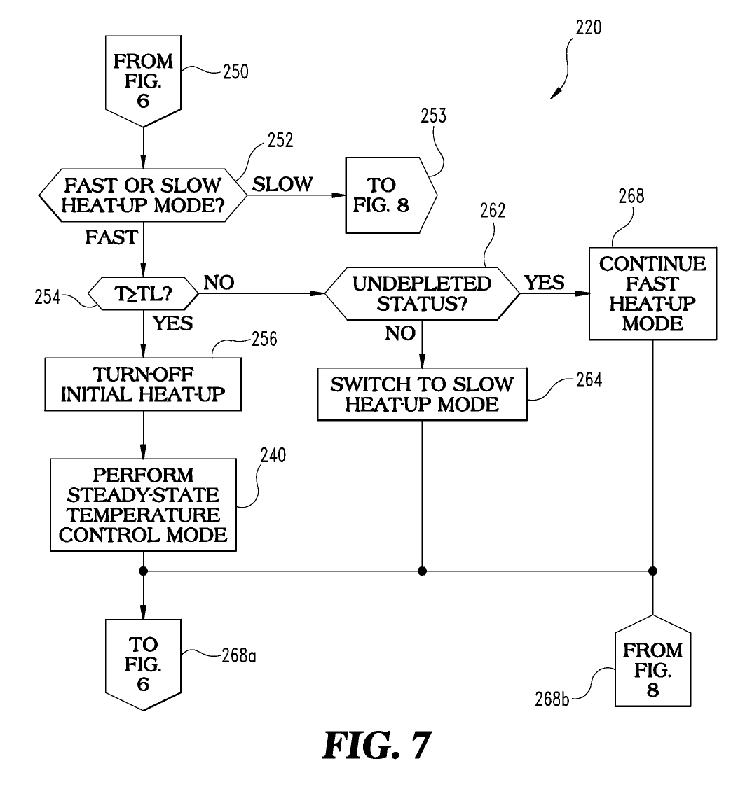

FIGS. 6-8 illustrate a flow chart of procedure 220 that can be implemented with heating system 20 (including heating circuitry 40); however, other implementations may be performed completely or partially independent of heating system 20 and/or heating circuitry 40. Procedure 220 describes various processes, operations, and variants thereof to apply heat to vehicle device 25 in general and more specifically steering wheel 30, as an example of vehicle device 25. Furthermore, as previously introduced in connection with heating circuitry 40, procedure 220 involves the performance of several different modes of heat application. In advance of describing the substantive details of procedure 220 specifically, a brief description of the flow chart symbology utilized in FIGS. 6-8 follows to enhance the speed and ease of understanding procedure 220. Centered at the top and bottom of FIG. 6, entry and exit points of procedure 220 are represented by oval shapes enclosing the text “START” and “RETURN,” respectively. In FIGS. 6-8, each square or rectangular shape encloses a brief textual description of one or more operations (each is also designated by reference numeral), and each six-sided shape (a “elongated” diamond) designates a conditional enclosing a test, question, or decision ending in a question mark “T” (each is also designated by a reference numeral). Each line connecting one enclosed shape to another is designated a “flow,” “branch,” “segment,” “flow line,” or the like. A flow is unidirectional—designating only one valid direction for procedure 220 to follow when following that flow. No matter how many segments departing from different symbols join together to constitute a flow, such flow only has one terminating arrowhead, which points to the next symbol to be considered per that unidirectional flow. For instance, see the bottom left of FIG. 6, where the branches of conditionals 230 and 242 join together to terminate in an arrowhead pointing to operation 240. For any square/rectangular operation symbol, only one flow points to it with an arrowhead and only one flow departs from it ending in an arrowhead pointed at the next symbol to be considered. For a given conditional, only one flow ends in an arrowhead pointing to it, but a conditional has two departing branches each ending in its own arrowhead that points to two different symbols—the selection of which depends on the result of the decision, test, question, or the like of the subject conditional. Another type of symbol has a circle shape, which appear in pairs with each one on a different figure of the flow chart. Each corresponding pair of circles are flow connectors that link the flow between these different figures (each is also designated by a reference numeral). The flow departing a figure points to the corresponding flow connector with an arrowhead and the circle encloses the label of the destination figure. For instance, on FIG. 6, flow connector 235 on the left encloses “TO FIG. 7” and points to it with an arrowhead indicating the flow direction is to the other circle of its pair on FIG. 7—namely flow connector 250 that encloses “FROM FIG. 6” at the top towards the right of FIG. 7. In this way flow connector 235 on FIG. 6 provides a unidirectional link to flow connector 250 on FIG. 7, while the flow connector pair of circles linking FIG. 7 back to FIG. 6 are designated by reference numerals 268a on FIGS. 7 and 246 on FIG. 6, respectively.

Some implementations maximize the degree to which operations and conditionals of procedure 220 can be executed in accordance with operating logic by heating circuitry 40 in general and control circuitry 50 more specifically. As introduced in connection with FIGS. 3-5 and accompanying description, the present application provides for the performance of multiple modes of providing heat to vehicle device 25 generally and steering wheel 30 especially. Procedure 220 further describes various modes for providing heat to steering wheel 30 via heating element 32 in process terms using heating system 20 and corresponding heating circuitry 40 (See, FIGS. 1 & 2). Heating circuitry 40 includes two sources of electric power: vehicle power supply 60 and the rechargeable energy source 70 as best seen in FIGS. 3 & 4. Procedure 220 most explicitly describes three different modes of providing heat to steering wheel 30 with heating element 32: (a) a fast heat-up mode that increases the temperature T of steering wheel 30 the most rapidly by using electric power from both vehicle power supply 60 and the rechargeable energy source 70 by coupling them in electrical series so the respective DC supply voltage and DC source voltage are generally additive, (b) a slow heat-up mode that increases the temperature T of steering wheel 30 with the vehicle power supply 60 more slowly than the fast heat-up mode because rechargeable energy source 70 has become depleted (such that heating element 32, voltage power supply 60 and rechargeable energy source 70 are coupled in parallel)—this mode also charges the rechargeable energy source concurrently, and (c) the steady-state temperature control mode using steady-state temperature control circuitry 140a that provides steering wheel 30 sufficient heat to approximately maintain temperature T at target level TL once target level TL for the temperature has been reached through one or both of the other modes.

Procedure 220 receives input signals from monitoring circuitry 42 (FIG. 3) and detection circuitry 130 (FIG. 4), processes them per operating logic executed with control circuitry 50 to provide appropriate output control signals to the switch circuitry 80 (including connection switch 52), detection circuitry 130, and amplifier circuitry 150 (FIGS. 3-5). Vehicle power supply 60 also provides a DC voltage bus 61 to power various circuits (FIGS. 3-5), rechargeable energy source 70 provides source output signals to switch circuitry 80 and the detection circuitry 130 (FIG. 4), and amplifier circuitry 150 provides an amplified output signal to the connection switch 52 (FIG. 5). The operating logic may include dedicated or general analog circuitry; synchronous or asynchronous digital circuitry; appropriate hybrid circuitry; hardwired, firmware, volatile and/or nonvolatile programming instructions executed with control circuitry 50 as appropriate for the various operations and conditionals of procedure 220.

Procedure 220 starts in the center at the top of FIG. 6 with the “START” entry oval and then immediately proceeds to conditional 222. Conditional 222 tests whether warming of steering wheel 30 by electrically energizing heating element 32 is to be performed. If the test is negative (“NO”) procedure 220 loops back to continue performing conditional 222 until the result is affirmative (“YES”). From conditional 222, procedure 220 continues with operation 224. In operation 224, heat-up of steering wheel 30 with heating element 32 is initiated and the steady-state maintenance of an elevated temperature level (“TL”), as performed with circuitry 140a is disabled.

Procedure 220 proceeds to operation 226. In operation 226, control circuitry 50 sends appropriate control signals to switch circuitry 80 to electrically couple vehicle power supply 60 in electrical series with rechargeable energy source 70. Heating element 32 is also in electrical series with vehicle power supply 60 and rechargeable energy source 70 to receive the sum of the respective DC supply voltage and DC source voltage thereacross. Accordingly, this high output voltage provides for the flow of more electric current through an electrically resistive form of heating element 32 compared to a lesser voltage of vehicle power supply 60 alone. This higher voltage and current provides for an increase in power electrically dissipated by element proportional to the square of the voltage. Namely, for DC power P is equivalent to the (DC voltage V)²/(electrical resistance R of heating element 32), such that P=V²/R. Accordingly, doubling the voltage V provides for quadruple the power P for a given fixed heating element 32 resistance R. In correspondence, operation 226 provides for a faster heat-up of steering wheel 30 in thermally conductive contact with heating element 32, and more rapidly increases steering wheel temperature T compared to a standard vehicle power supply 60 across heating element 32 alone without rechargeable energy source 70 in electrical series therewith.

From operation 226, procedure 220 continues with operation 228. Operation 228 determines the steering wheel temperature T detected with temperature sensor 34 of monitoring circuitry 42 (e.g. sampling an electrical input from thermistor 34a). From operation 228, conditional 230 is next performed. Conditional 230 tests whether steady-state temperature control with circuitry 140a has been enabled. Because conditional 230 is initially encountered from operations 224, the test is negative (NO) and procedure 220 proceeds along the negative branch (NO) of conditional 230 from connector 235 of FIG. 6 to connector 250 of FIG. 7. In FIG. 7, connector 250 encounters conditional 252 that tests whether steering wheel 30 is being initially heated-up in the fast mode or the slow mode. If the test of conditional 252 indicates the fast mode, procedure 220 continues with conditional 254. Conditional 254 tests whether the temperature T of the steering wheel 30 exceeds the target level TL (T>TL). If the test is affirmative (YES), procedure 220 next encounters operation 256 that turns-off the fast mode of steering wheel heat-up as indicated by its origin via the FAST branch of conditional 254. From operation 256, operation 240 to enable and perform steady-state temperature control is encountered as previously described in connection with FIG. 6. From operation 240 of FIG. 7, flow connector 268a returns procedure to operation 228 via flow connector 246. In operation 228, temperature T is determined and procedure 220 proceeds to conditional 230; however, because steady-state temperature control was enabled in operation 240 of FIG. 7, the test of conditional 230 is affirmative (YES) this time. The affirmative branch of conditional 230 proceeds with performance of steady-state temperature control in operation 240 of FIG. 6 to enable and perform steady-state control of temperature T relative to temperature level TL with circuitry 140a in the manner previously described. It should be appreciated that operation 240 involves control circuitry 50 directing SPST connection switch 52 of circuitry 80 with control coupling 51e. In response, common contact 53 of connection switch 52 electrically couples with steady-state switch contact 53b that correspondingly electrically couples steady-state temperature circuitry 140a via control coupling 51c.

Procedure 220 continues with conditional 242. Conditional 242 tests whether to turn-off warming/heating of steering wheel 30 with heating element 32. If the test of conditional 242 is affirmative (YES), procedure 220 halts or returns until re-activated with operator input device 38. If the test of conditional 242 is negative (NO), such that warming/heating of steering wheel 30 continues, procedure 220 loops back to again perform steady-state temperature control operation 240. After operation 240 is performed once more, the negative branch of conditional 242 (NO) continues to loop back to operation 240 until warming/heating is turned-off following the affirmative branch (YES) of conditional 242 until halting steering wheel heating.

Returning to conditional 254 of FIG. 7, if the corresponding test is negative, conditional 262 is next encountered. Conditional 262 tests whether the status of rechargeable energy source 70 is undepleted. If the result is negative (NO), meaning rechargeable energy source 70 is depleted, then procedure 220 executes operation 264. Operation 264 switches from performance of the fast mode of heating-up steering wheel 30 with heating element 32 (as indicated by the preceding FAST branch of conditional 252) to the slow heat-up mode. Correspondingly, control circuitry 50 directs switch circuitry 80 to convert from the electrical series circuit connection of vehicle power supply 60, rechargeable energy source 70, and heating element 32; to the parallel circuit connection of vehicle power supply 60, rechargeable energy source 70, and heating element 32 via control couplings 51d. This parallel circuit connection provides for recharging the energy-depleted rechargeable energy source 70, while also heating-up steering wheel 30 with parallel heating element 32 in the slow mode. After execution of operation 264, procedure 220 then proceeds to flow connector 268a of FIG. 7 to return to operation 228 of FIG. 6 via flow connector 246. Returning to the affirmative (YES) branch of conditional 262, meaning rechargeable energy source 70 is not depleted, operation 268 is encountered that continues to execute the fast heat-up mode of steering wheel 30 with heating element 32 as results from the preceding FAST branch of conditional 252. Consequently, the performance of operations and conditionals of FIGS. 6 and 7 of procedure 220 have been described as linked by flow connectors 235 and 250 to provide flow control from FIG. 6 to FIG. 7 and connectors 268a and 246 to provide flow control form FIG. 7 to FIG. 6.

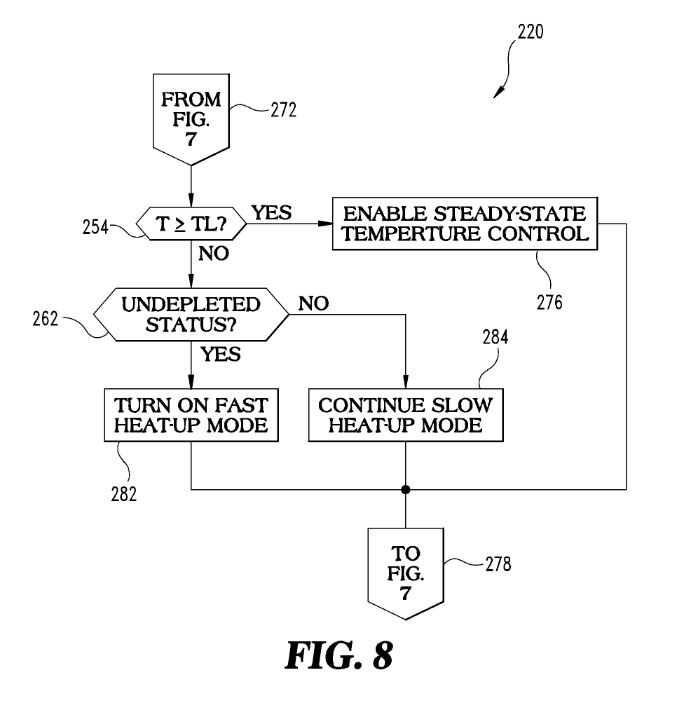

Flow connector 253 of FIG. 7 proceeds to flow connector 272 of FIG. 8. From connector 272, conditional 274 is encountered. Conditional 274 tests whether temperature T of steering wheel 30 is greater than or equal to the target level for the steering wheel temperature (T>TL). If the test is affirmative (YES), procedure 220 enables steady-state temperature control with circuitry 140a by executing operation 276, and then encounters flow connector 278 of FIG. 8 to link with flow connector 268b of FIG. 7. On FIG. 7, flow connector 268b from FIG. 8 provides an unconditional, direct linkage with flow connector 268a to FIG. 6. In turn, procedure 220 returns from flow connector 268a of FIG. 7 to flow connector 246 of FIG. 6 to determine temperature T of steering wheel 30 by executing operation 228. On the other hand, if the test of conditional 274 is negative (NO), operation 284 is executed to continue the slow heat-up mode for steering wheel 30. It should be kept in mind that the linkage from flow connector 253 of FIG. 7 to flow connector 272 corresponds to the SLOW heat-up mode branch of conditional 252 of FIG. 7, which is congruent with the execution of operation 284 of FIG. 8. Like operation 276, operation 284 of FIG. 8 encounters flow connector 278 to ultimately return to operation 228 of FIG. 6 via the flow connector 278 from FIG. 8 to flow connector 268b on FIG. 7—with direct, unqualified linkage to flow connector 268a of FIG. 7 to flow connector 246.

Several other variations, implementations, forms, and features of the present application are envisioned. In one example, a process includes: energizing a heating element with a DC voltage supply and a DC rechargeable source to increase a temperature of a steering wheel at a first rate; increasing the temperature at a second rate less than the first rate with the heating element energized from the DC voltage supply after detecting the DC rechargeable source is depleted; reaching a target level of the temperature; and controlling energization of the heating element to approximately maintain the temperature at the target level.

Yet another example comprises: energizing a heating element with first voltage including a supply voltage added to a source voltage from a rechargeable source to increase temperature of a steering wheel at a first rate; increasing the temperature at a second rate less than the first rate with the heating element energized by the supply voltage after detecting a depletion of the rechargeable source; determining the temperature reaches a target level; and controlling energization of the heating element to approximately maintain the temperature at a target level.

Another example is directed to a process, comprising: energizing a heating element to increase a temperature of a steering wheel at a first rate from a vehicle power supply electrically coupled to a rechargeable energy source; detecting an energy depletion of the rechargeable energy source; increasing the temperature at a second rate less than the first rate with the heating element energized from the vehicle power supply in response to the energy depletion; and controlling energization of the heating element to approximately maintain the temperature at a target level when the temperature reaches the target level.

In a further instance a method according to the present application includes: heating a steering wheel with a heating element energized by a first voltage from the DC power supply and a DC rechargeable source; providing heat to the steering wheel with the heating element energized by a second voltage output by the DC power supply less than the first voltage in response to an operation state change caused by the heating; and recharging the DC rechargeable source with the second voltage.

Still a further example is directed to a different process, comprising: heating-up a steering wheel with a heating element energized by a DC supply voltage added to an output voltage of a DC rechargeable source; heating the steering wheel with the heating element energized by the DC supply voltage in response to an operational state change caused by the heating; and recharging the DC rechargeable source with the DC supply voltage.

A different example comprising: energizing a heating element to raise a temperature of a steering wheel at one rate with a first voltage from a DC power supply and a DC rechargeable source; increasing the temperature at another rate less than the one rate with the heating element energized with the DC power supply in response to an operational state change caused by the energizing; and recharging the DC rechargeable source with the DC power supply.

A further process of the present application comprises: increasing a temperature of a steering wheel at one rate with a heating element energized by a first voltage greater than a DC power supply voltage; heating the steering wheel with the heating element energized by no more than the DC power supply voltage in response to the operational state change cause by the increasing; and recharging a DC rechargeable source with the DC power supply voltage.

A different example is directed to an apparatus, comprising: a vehicle and a heating system carried thereby. The heating system includes: a vehicle device selected from the group consisting of: a steering wheel, a seat base, a seat back, a vehicle-mounted cushion, a headrest, an armrest, a center console, a floorboard, a floor mat, a window, a windshield, a vehicle-mounted camera, and a vehicle-mounted mirror. This system further includes: a heating element, a vehicle power supply to output a DC supply voltage, a rechargeable energy source to output a DC source voltage, and an operator input device to initiate heat-up of the vehicle device by the heating element. Also included is control circuitry responsive to the operator input device to provide the vehicle power supply, the rechargeable energy source, and the heating element in a first circuit to output a first DC voltage to electrically energize the heating element to increase a temperature of the vehicle device at a first rate. The control circuitry couples the vehicle power supply and the rechargeable energy source in a second circuit to output a second DC voltage less than the first DC voltage in response to an operational state change of the heating system and the second circuit is operable to electrically couple the rechargeable energy source across the second DC voltage to recharge the rechargeable energy source.

Any patent, patent application, or other document cited in the present application is hereby incorporated by reference in its entirety herein—except to the extent expressly stated to the contrary. Any conjecture, discovery, example (prepared or prophetic), experiment, estimation, finding, guesswork, hypothesis, idealization, investigation, operating principle or mechanism, model, representation, speculation, theory, test, test/experimental results, or the like relating to any aspect of the present application is provided to enhance understanding thereof without restricting any patent claim that follows—except to the extent expressly and unambiguously recited to the contrary. The organization of application content under one or more headings promotes application readability or otherwise conforms to certain requirements; however, these headings have no effect as to the scope, meaning, substance, or “prior art” status of such content, unless unambiguously expressed to the contrary thereunder.

No patent claim hereof should be understood to include a “means for” or “step for” performing a specified function (“means plus function clause” or “step plus function clause”) unless signaled by expressly reciting “means for . . . ” or “step for . . . ” before description of a specified function in such clause. Absent an unambiguous indication to the contrary, aspects recited in a process or method claim, including clauses, elements, features, gerund phrases, limitations, or the like may be performed in any order, and any two or more of the same may be performed concurrently or overlapping in time. Indeed, no order of such aspects results just because the process/method claim: (a) recites one of these aspects before another, (b) precedes the first occurrence of an aspect with an indefinite article (“a” or “an”) or no (zero) article (as is commonplace for plural aspects, gerunds, and certain other types of terminology), (c) precedes one or more subsequent occurrences of such aspect with a definite article (“the” or “said”), or (d) the process/method claim includes alphabetical, cardinal number, or roman numeral labeling to improve readability, organization, or the like without any unambiguous express indication that such labeling intends to impose a particular order. Further, to the extent order is imposed as to two or more process/method claim aspects, the same does not impose an order as to any other aspects listed before, after, or between them.

The foregoing has been presented for purposes of representative illustration and description. It is not intended to be exhaustive or to limit any patent claim appended hereto. Obvious modifications and variations may result from the above teachings. All such modifications and variations are within the scope of the appended patent claims when interpreted in accordance with the breadth to which they are fairly, legally, and equitably entitled. Only representative adaptations, additions, alternatives, apparatus, applications, arrangements, articles, aspects, circuitry, configurations, developments, devices, discoveries, features, forms, implementations, instrumentalities, kits, machines, manufactures, mechanisms, methods, modifications, operations, options, procedures, processes, refinements, systems, upgrades, uses, vehicles, variants of any of the foregoing, or the like have been described, such that any patent claims that follow are desired to be protected.

What is claimed:

1. A method, comprising:
energizing a heating element with a DC voltage supply and a DC rechargeable source to increase a temperature of a steering wheel at a first rate;
increasing the temperature at a second rate less than the first rate with the heating element energized from the DC voltage supply after detecting the DC rechargeable source is depleted;
reaching a target level of the temperature; and
controlling energization of the heating element to approximately maintain the temperature at the target level.

2. The method of claim 1, further comprising charging the DC rechargeable source with the DC voltage supply.

3. The method of claim 2, further comprising:
performing the charging of the DC rechargeable source during at least one of the increasing of the temperature and the controlling of the energization;
providing the DC voltage supply with a three-phase AC generator, conversion circuitry electrically coupled to the three-phase AC generator, and a first rechargeable electrochemical energy storage device;
supplying an AC electric power input to the conversion circuitry from the three-phase AC generator;
converting the AC electric power input to a DC voltage output with the conversion circuitry; and
providing the DC rechargeable source as a second rechargeable electrochemical energy storage device.

4. The method of claim 1, further comprising:
operating a first circuit including the DC voltage supply, the DC rechargeable source, and the heating element to provide a first DC voltage to the heating element from the DC voltage supply and the DC rechargeable source for the energizing of the heating element; and
reconfiguring the DC voltage supply, the DC rechargeable source, and the heating element to define a second circuit therefrom; and
providing a second DC voltage to the heating element for the increasing of the temperature at the second rate from the DC voltage supply in the second circuit, the second DC voltage being less than the first DC voltage to deliver less electric power to the heating element than the first circuit.

5. The method of claim 4, further comprising:
operating the first circuit with the DC rechargeable source coupled in electrical series with the DC voltage supply;
supplying the first DC voltage across the heating element with the first circuit, the first DC voltage being less than or equal to a DC supply voltage output by the DC voltage supply summed with a DC source voltage output by the DC rechargeable source;
operating the second circuit with the DC voltage supply electrically coupled in parallel with the DC rechargeable source; and
supplying the second DC voltage across the heating element with the second circuit, the second DC voltage being less than or equal to the DC voltage supply voltage.

6. The method of claim 4, further comprising:
operating switch circuitry to perform the reconfiguring of the DC voltage supply, the DC rechargeable source, and the heating element to define the second circuit;
recharging the DC rechargeable source with the second DC voltage during at least one of the increasing of the temperature and the controlling of the energization;
directing the switch circuitry to define a third circuit including the heating element and amplifier circuitry with control circuitry, the heating element being electrically coupled to an output of the amplifier circuitry to perform the controlling of the energization of the heating element; and
varying the energization of the heating element during the controlling in response to a modulated control signal generated by the control circuitry and input to the amplifier circuitry from the control circuitry.

7. A method, comprising:
heating a steering wheel with a heating element energized by a first voltage from a DC voltage supply and a DC rechargeable source;
providing heat to the steering wheel with the heating element energized by a second voltage output by the DC voltage supply less than the first voltage in response to an operational state change caused by the heating; and
recharging the DC rechargeable source with the second voltage.

8. The method of claim 7, in which the operational state change includes a temperature of the steering wheel reaching a target level and the providing of the heat to the steering wheel includes:
generating a modulated control signal with control circuitry;
supplying a time-varying energization to the heating element in response to the modulated control signal; and
controlling the temperature to approximately sustain the target level.

9. The method of claim 7, which includes:
supplying a modulated control signal with control circuitry;
generating a time-varying amplified energization signal with amplifier circuitry powered by the second DC voltage from the DC voltage supply in response to the modulated control signal; and
providing the time-varying amplified energization signal to power the heating element.

10. The method of claim 7, wherein the operational state change includes depletion of the DC rechargeable source before a temperature of the steering wheel attains a target level, the heating increases the temperature at a first rate; and the providing of the heat to the steering wheel raises the temperature at a second rate less than the first rate.

11. The method of claim 10, further comprising:
determining the temperature reaches the target level in response to the providing of the heat to the steering wheel at the second rate with control circuitry; and
providing a time-varying amplified energization signal to the heating element with amplifier circuitry to control the temperature relative to the target level.

12. The method of claim 11, further comprising:
halting steering wheel heating;
activating the heating of the steering wheel in response to an operator input device;
initially performing the heating of the steering wheel with a first circuit including the DC voltage supply, the DC rechargeable source, and the heating element, wherein the DC rechargeable source and the DC voltage supply are coupled together in electrical series in the first circuit to output the second DC voltage, the second DC voltage being less than or equal to a DC supply voltage output by the DC voltage supply summed with a DC source voltage output by the DC rechargeable source, and the heating element is electrically coupled across the DC rechargeable source and the DC voltage supply;
detecting the depletion of the DC rechargeable source with detection circuitry;
determining the temperature attains the target level with monitoring circuitry;
operating switch circuitry to reconfigure the DC voltage supply, the DC rechargeable source, and the heating element in the first circuit to a second circuit including the DC rechargeable source, the DC voltage supply, and the heating element with different connectivity than the first circuit, wherein the heating element is electrically coupled across the DC voltage supply and the DC rechargeable source is electrically parallel to the DC voltage supply in the second circuit, the second DC voltage is less than or equal to the DC supply voltage output by the DC voltage supply, and the amplifier circuitry and the switch circuitry respond to the control circuitry; and
responding to the input device with the control circuitry.

13. The method of claim 12, further comprising:
detecting the temperature with a first temperature sensor; and
adjusting an operator input control device with a first setting to perform the activating of the heating of the steering wheel and a second setting to turn off the steering wheel heating.

14. The method of claim 7, further comprising:
providing the DC voltage supply with a three-phase AC generator, conversion circuitry electrically coupled to the three-phase AC generator, and a first rechargeable electrochemical energy storage device;
supplying an AC electric power input to the conversion circuitry from the three-phase AC generator;
converting the AC electric power input to a DC voltage output with the conversion circuitry; and
providing the DC rechargeable source as a second rechargeable electrochemical energy storage device.

15. An apparatus, comprising: a vehicle and a heating system carried thereby, the heating system including:
a vehicle device selected from the group consisting of: a steering wheel, a seat base, a seat back, a vehicle-mounted cushion, a headrest, an armrest, a center console, a floorboard, a floor mat, a window, a windshield, a vehicle-mounted camera, and a vehicle-mounted mirror;
a heating element;
a vehicle power supply to output a DC supply voltage;
a rechargeable energy source to output a DC source voltage;
an operator input device to initiate heat-up of the vehicle device by the heating element;
control circuitry responsive to the operator input device to provide the vehicle power supply, the rechargeable energy source, and the heating element in a first circuit to output a first DC voltage to electrically energize the heating element to increase a temperature of the vehicle device at a first rate; and
in which the control circuitry couples the vehicle power supply and the rechargeable energy source in a second circuit to output a second DC voltage less than the first DC voltage in response to an operational state change of the heating system, the second circuit is further operable to electrically couple the rechargeable energy source across the second DC voltage to recharge the rechargeable energy source.

16. The apparatus of claim 15, in which:
the vehicle device is the steering wheel, the heating element is positioned between a structural support of the steering wheel and an outer surface of the steering wheel;
the vehicle power supply includes: a three-phase AC generator, conversion circuitry to convert an AC electric power input from the three-phase AC generator to the DC supply voltage, and a first rechargeable electrochemical energy storage device electrically coupled to the DC supply voltage; and
the rechargeable energy source is structured as a second rechargeable electrochemical energy storage device.

17. The apparatus of claim 16, in which:
the first rechargeable electrochemical energy storage device includes one or more first device electrochemical cells;
the second rechargeable electrochemical energy storage device includes one or more second device electrochemical cells;
the rechargeable energy source is coupled in electrical series with the vehicle power supply in the first circuit, the first DC voltage is less than or equal to the DC supply voltage summed with the DC source voltage, and the heating element is electrically coupled across the first DC voltage in the first circuit; and
the heating element is electrically coupled across the vehicle power supply and the rechargeable energy source in the second circuit, and the second DC voltage is less than or equal to the DC supply voltage.

18. The apparatus of claim 15, in which:
the vehicle device is the steering wheel for the vehicle; and
the heating system includes means for detecting a depletion of the rechargeable energy source.

19. The apparatus of claim 15, in which the operational state change of the heating system corresponds to a depletion of the rechargeable energy source, and the second circuit raises temperature of the steering wheel at a second rate less than the first rate.

20. The apparatus of claim 15, in which the vehicle device is the steering wheel, the control circuitry generates a modulated output signal and further comprising:
monitoring circuitry operable to determine the temperature is approximately at a target level, and the change in the operational state of the heating system corresponds to the temperature reaching the target level; and
amplifier circuitry responsive to the modulated output signal from the control circuitry to drive the heating element with a time-varying signal to approximately sustain the temperature at the target level.
